(19) United States
(12) Patent Application Publication
(10) Pub. No.: US 2015/0305978 A1
(43) Pub. Date: Oct. 29, 2015

(54) INSULATION DEVICE FOR BLOOD BAG

(71) Applicant: OHIO STATE INNOVATION FOUNDATION, Columbus, OH (US)

(72) Inventors: Charles H. Cook, Bexley, OH (US); Kay Ashworth, Columbus, OH (US); Scott R. Scrape, Columbus, OH (US)

(21) Appl. No.: 14/443,188

(22) PCT Filed: Nov. 20, 2013
(86) PCT No.: PCT/US13/71024

§ 371 Date: May 15, 2015

Related U.S. Application Data
(60) Provisional application No. 61/728,344, filed on Nov. 20, 2012.

(51) Int. Cl. A61J 1/16; A61J 1/14; A61J 1/18; A61J 1/10

(52) U.S. Cl. CPC A61J 1/165; A61J 1/10; A61J 1/1462; A61J 1/18

(57) ABSTRACT

A device configured to receive and insulate a blood bag. The device includes a first side wall and a second side wall coupled to the first side wall and forms a cavity configured to receive the blood bag. The device is in contact with the blood bag over a majority of the surface area of the blood bag. The device also includes a plurality of individual pockets filled with air having a pocket density (e.g., the number of pockets per square centimeter) in a range of about 0.005-50 pockets per square centimeter. The device also includes a defined area absent the pockets with the defined area configured to cover at least a portion of a label on the blood bag such that the label remains human readable.

### FIELD OF THE INVENTION

Embodiments of the present invention relate to blood bags and in particular, insulation devices for blood bags that aid in the transportation, storage, and maintenance of blood bags.

### BACKGROUND OF THE INVENTION

Blood is a connective tissue that is made up of two parts: plasma and a cellular portion. The plasma, which makes up about 55% of blood, is the liquid portion of blood that contains nutrients (i.e., glucose, fats, and amino acids), chemicals (i.e., sodium, potassium, and calcium), special proteins, and hormones. The cellular portion, which comprises about 45% of blood, includes erythrocytes, leukocytes, and thrombocytes, which are more commonly referred to as red blood cells, white blood cells, and platelets, respectively. Red blood cells participate in oxygen transport, white blood cells provide defense against microorganisms, and platelets contribute clotting capabilities. Together with the functions listed above, the components of blood also provide waste product removal and body temperature regulation. In other words, the components of blood participate in maintaining the body's homeostatic equilibrium (i.e., the body's stable internal environment), which is fundamental to the many dynamic processes carried out by the body. However, a wide variety of disorders and injuries target and deplete one or all of the contents of blood. As such, treatment for disorders and injuries of this type often require blood transfusions to supplement or replace lost components of blood necessary to maintain normal blood levels and concentrations.

Blood transfusions are highly regulated because blood has a composition that is highly sensitive to small changes in both pH levels and temperature. In addition, there is a risk of bacterial contamination of products related to collection and storage temperature. In order to ensure that the functionality of each of the vital components of blood is maintained, and to minimize the risk of bacterial infections, the temperature of the blood must be maintained within a strict range. Because more than 3,000 blood establishments in the United States collect and process about 14 million units of whole blood donated by volunteers each year, a system that ensures effective temperature regulation is necessary.

### SUMMARY OF THE INVENTION

Blood bags or containers are used to store donated blood for use in blood transfusions. Blood bags are subject to strict regulatory requirements that ensure proper retrieval, storage, and administration of blood throughout the process from donor to recipient. First, the blood bags are required to be sterile, pyrogen free, and disposable, with a closed system of collection that complies with standards provided by the International Organization for Standardization (ISO) and the Information Sciences Institute (ISI). Further, multiple interconnected plastic bags (i.e., a closed system) should be used for blood component preparation (i.e., extraction of white blood cells from whole blood, for example). Additionally, blood bags must contain an anti-coagulant (i.e., CPD+SAG-M or CPDA, for example) to reduce clotting factors included as part of a standard composition of blood.

Once blood has been collected from a donor, the temperature at which the blood is maintained is highly regulated. Immediately after collection, whole blood (i.e., blood that contains all of its components) needs to be cooled then maintained within a temperature range of 4° C.-6° C.±2° C. During component preparation from whole blood it needs to be stored at 22° C.±2° C. until the platelets have separated.

Transportation of blood bags requires compliance with standards on the basis of what each bag contains. For example, red blood cells and whole blood must be maintained within a temperature range of 1° C.-10° C. during transport, while platelet and granulocyte (a type of white blood cell) concentrate must be maintained at 22° C.±2° C. during transport. Additionally, blood components that are stored frozen are required to remain frozen during transport. The temperature of all blood components necessarily needs to be measured and recorded every 4 hours. When whole blood or packed red blood cells exceed the temperature threshold of 10° C. they are considered unsafe for use, and are discarded.

Storage of blood bags is also regulated based on the contents of each bag. Therefore, red blood cells and whole blood must be stored at a temperature in the range of 1° C.-6° C. and platelets and granulocytes must be stored at a temperature in the range of 20° C.-24° C. Further, platelets should be stored with gentle agitation. All blood bags need to be in a clean and dry (i.e., less than 60% humidity) environment, as well. The temperature in the marked storage containers must be monitored by a temperature monitoring system or in the absence of such a system, the temperature within the container is required to be measured and recorded every 4 hours. The containers should not be the original carton boxes used for delivery, nor should blood bags be stored directly on the floor. Rather, it is recommended to store the containers on palettes.

Transfusion of blood products is a multistep process that is highly regulated. After typing and cross-matching are performed, individual units are identified and assigned to a specific recipient. Such assignment requires the use of a variety of tags and labels that must remain freely visible during this clerical process as well as at the point of administration. Properly identified and labeled blood products are then removed from refrigerated storage and transported (typically at ambient or room temperature) within the medical facility to the specific recipients point of care. Prior to transfusion and at the point of care, administering health care providers are required to perform a visible inspection of the blood product(s). In addition, a clerical confirmation between two health care providers is performed to confirm that the assigned blood product(s) received matches the assigned recipient. Such clerical confirmation requires cross-checking the various labels and tags attached to the blood product bag prior to infusion. Following these confirmations, the product is “spiked” with the appropriate blood infusion tubing and administered to the recipient. During transportation, clerical confirmation, and administration the blood bags are either being directly handled or maintained at ambient temperature. Most institutions require that such transfusions be completed within four hours after initiation.

Various embodiments of blood bag insulation devices that maintain acceptable blood temperatures for blood bags are proposed herein. The blood bag insulation devices disclosed herein include several features that comply with many of the regulatory standards listed above. For example, the blood bag insulation devices include time/expiration date information, temperature status indicators, non-porous material, and a clear window aligned with label indicia. It is also noted that the blood bag insulation devices are able to indicate the blood levels of the blood bags and allow access to and reinforce ports, tube and hang-holes that are characteristic of typical blood bags. The blood bag insulation devices enclosed herein may additionally include a color-coded system to indicate the type of blood in use. The blood bag insulation devices are constructed to fit a variety of manufactured blood bags and have a tough or resilient outer body. Further, the blood bag insulation devices are designed to keep the assembly and volume minimal as well as being collapsible and potentially reusable. The blood bag insulation devices are also equipped with common carrying systems to reduce blood bag handling, which increases the temperature of the blood contained within the blood bag.

In one embodiment, the invention provides a device configured to receive a blood bag. The device includes a first side wall and a second side wall coupled to the first side wall and forming a cavity configured to receive the blood bag. The device is in contact with the blood bag over a majority of the surface area of the blood bag. The device also includes a plurality of individual pockets filled with air having a pocket density (e.g., the number of pockets per square centimeter) in a range of about 0.005-50 pockets per square centimeter. The device also includes a defined area absent the pockets with the defined area configured to cover at least a portion of a label on the blood bag such that the label remains human readable.

Other aspects of the invention will become apparent by consideration of the detailed description and accompanying drawings.

### BRIEF DESCRIPTION OF THE DRAWINGS

FIG. 1 is a graphical representation that compares the temperature of an uninsulated blood bag to the temperature of an insulated blood bag where neither blood bag has been handled over a period of time.

FIG. 2 is a graphical representation that compares the temperature of an uninsulated blood bag to insulated blood bags having insulation devices constructed from various types of insulative materials where each of the blood bags has been handled for five minutes.

FIG. 3 illustrates two exemplary blood bags.

FIG. 4 illustrates four exemplary types of insulation devices that are used to insulate blood bags.

FIGS. 5A and 5B illustrate exemplary types of insulation foams that are used to insulate blood bags.

FIGS. 6-49 illustrate various embodiments of blood bag insulation devices.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected,” and “coupled” are used broadly and encompass both direct and indirect mounting, connecting and coupling. Further, “connected” and “coupled” are not restricted to physical or mechanical connections or couplings. Furthermore, and as described in subsequent paragraphs, the specific configurations illustrated in the drawings are intended to exemplify embodiments of the invention and that other alternative configurations are possible.

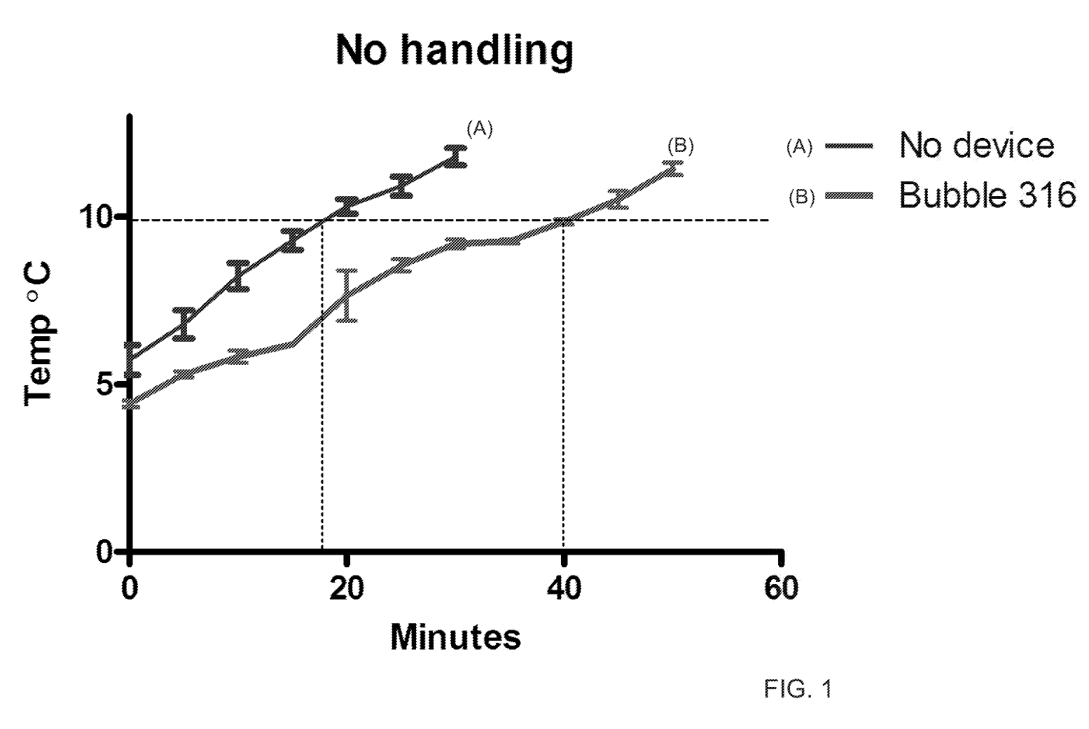

The present invention provides devices that reduce heat transfer into blood bags such that blood bags are viable for a longer period of time once removed from refrigerated storage. Blood removed from storage approaches ambient temperature at a rate dependent upon said temperature. FIGS. 1 and 2 illustrate the rate of change of temperature of blood in a blood bag with and without various types of insulation devices after transfer from refrigerated to ambient temperature that will be discussed in further detail below. Blood bags used without an insulation device remain viable (<10° C.) after transfer to ambient temperature for only a fraction of the time of blood bags used in conjunction with an insulation device. Reducing the heat transfer to blood therefore preserves donated blood for a longer period of time. The invention provides a means of insulation for blood bags and a method to reduce handling of blood bags. Direct handling of blood bags even for 5 minutes increases the rate of heat transfer to the blood and therefore, decreases the time period for which the blood bag is viable. As is evident by comparing FIGS. 1 and 2, handling of blood bags alone decreases the time they remain viable by nearly 50%. Therefore, insulation and transport mechanisms are implemented throughout the various embodiments to reduce the rate of temperature increase for blood bags.

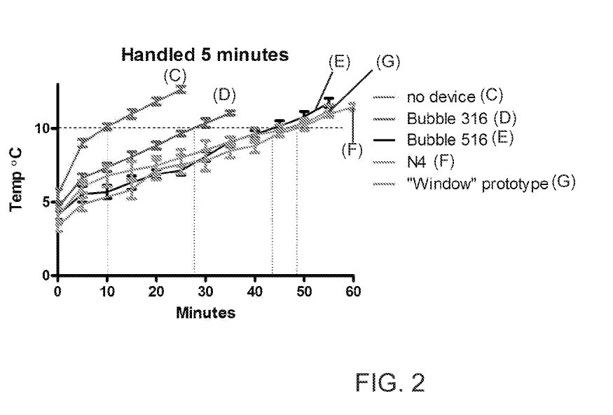

FIG. 3 illustrates two examples of standard non-reusable blood bags 10. The blood bag 10 is a polyvinyl chloride (PVC) container 12 having round edges 14 to avoid friction, to ensure smoother transition of blood components, and to reduce the amount of blood that goes unused (i.e., gets trapped). The blood bag 10 includes a first end 16 and a second end 18 with body 20 therebetween having a first side wall 22 and an opposite second side wall (not shown). The first and second side walls are coupled by a heat-welded seam 24 or other suitable construction to thereby form a cavity for receiving the blood. Accordingly, the cavity is defined by a top wall 34, a bottom wall 36, and first and second side walls 38, 40. The first end includes a plurality of ports 26 in addition to at least one tube 28, all of which are integrally formed and fluidly coupled with the body 20 of the blood bag 10. The second end includes a through-hole 30 or hanger-hole that is used to suspend the blood bag 10 from a holder or stand while in use. Each blood bag 10 includes a non-removable label 32 on one of the first or second side walls. The label 32 is moisture resistant and includes identification information required by the FDA (i.e., the type of blood, a color code, and time/day of expiration etc.). The illustrated blood bags 10 are merely exemplary as there are a wide variety of manufacturers for blood bags 10 which may include minor differences.

As described above with respect to blood bag standards and requirements, the temperature of blood must be maintained at or within a certain range of temperatures from the time of collection from a donor in order to remain viable for transfusion into a patient. Therefore, it is an object of the present invention to insulate the blood bags with an insulative material in order to reduce heat transfer and increase the amount of time available to transfer the blood to the patient. Several types of insulative materials that may be used alone or in combination are described below.

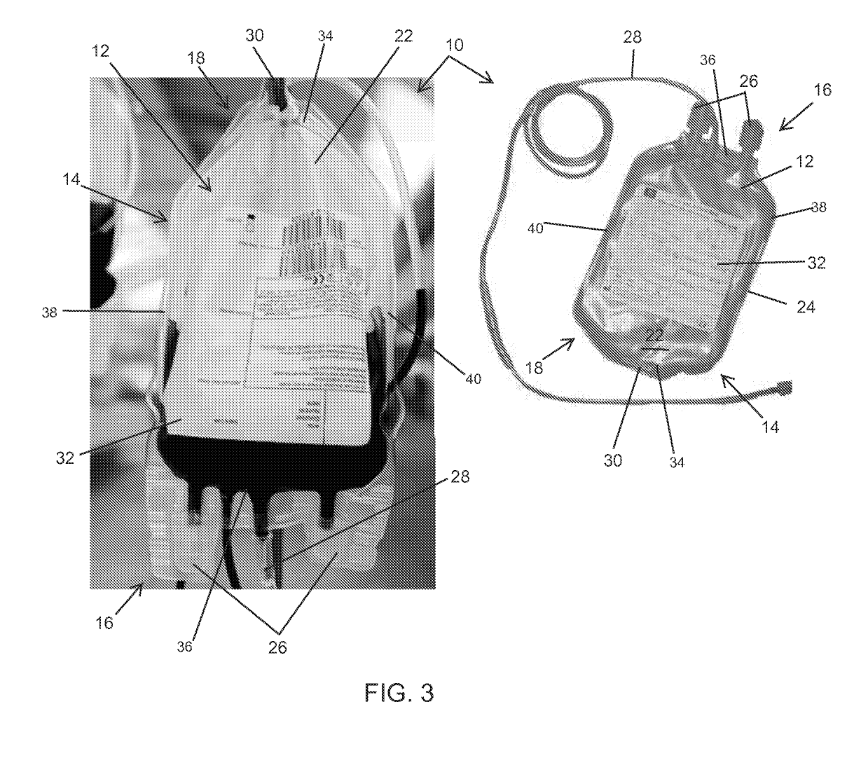

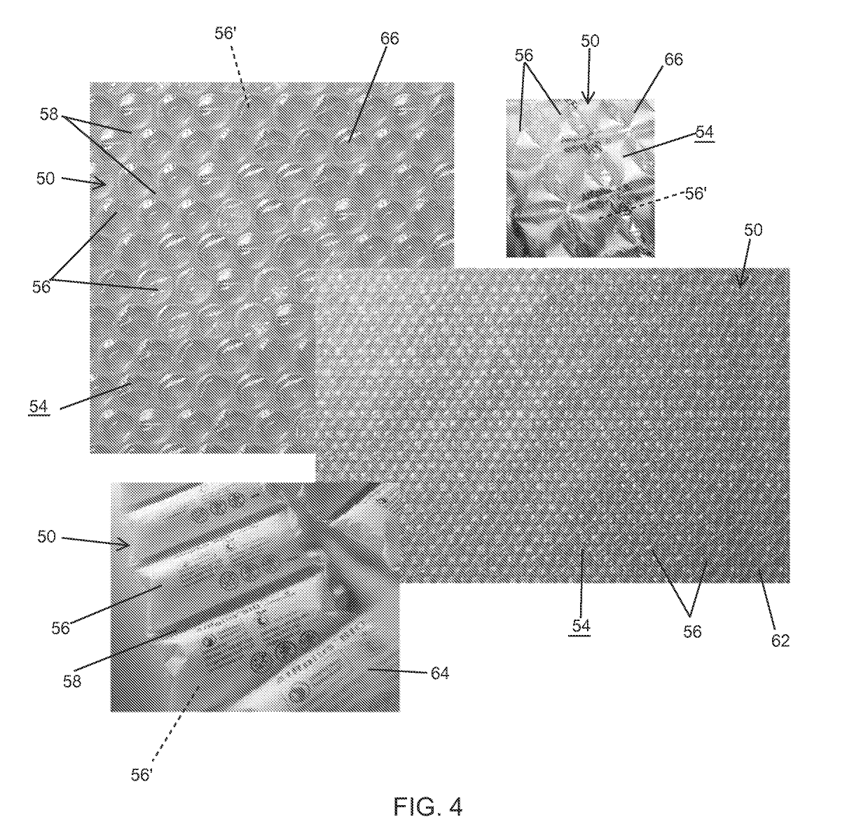

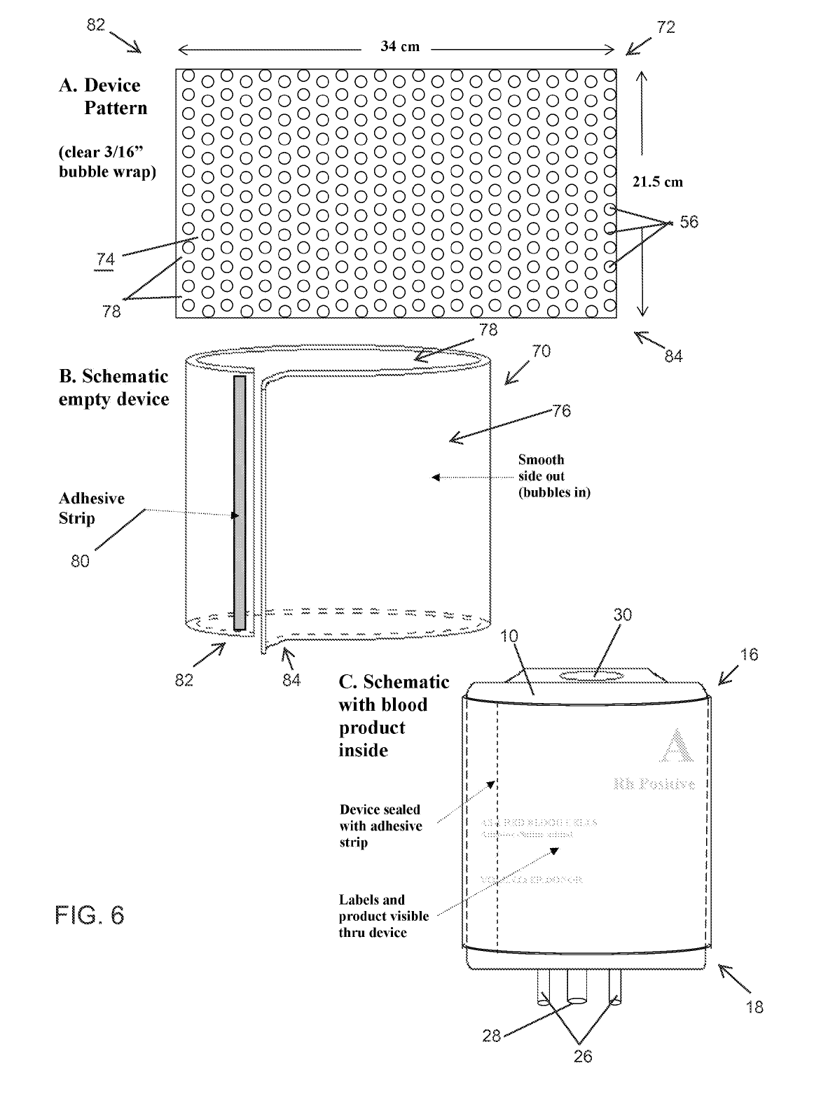

FIG. 4 illustrates an exemplary insulative material in the form of insulative plastic 50. The insulative plastic is constructed from poly-vinyl chloride (“PVC”) or an alternative low-density polyethylene (“LDPE”), either of which have low heat transfer coefficients and high values for specific heat capacity. A low heat transfer coefficient indicates that heat transfer will occur more slowly. Similarly, a high specific heat capacity value indicates that more energy is required to increase temperature. Therefore, while in a preferred embodiment the insulative plastic is constructed from PVC or LDPE, it is contemplated that other materials having low heat transfer coefficients and high values for specific heat capacity may be used. The insulative plastic also includes a first side as indicated at 76 of FIG. 6 and a second side 54, which is opposite the first side. The first side 52 is a generally smooth side while the second side 54 includes a plurality of enclosed pockets 56 or compartments. Alternatively, one or more of the enclosed pockets 56 can extend outwardly of both the first side 52 and the second side 54 such that the enclosed pocket 56 is defined by a portion of both the first side 52 and the second side 54. The pockets 56 include portions where the second side 54 and the first side 52 are directly coupled to one another such that the pockets 56 include definite boundaries 58. In other words, the pockets 56 are independent of one another. In a preferred embodiment, the pockets 56 are filled with air, which like PVC or LDPE has a low heat transfer coefficient and high specific heat; in further embodiments the pockets 56 may be filled with any other suitable substance (i.e., water or other gases). One of the sides 52, 54 interfaces with the blood bag (not shown), and the other side 52, 52 forms an exterior 60 of the insulator. The above-described features of the insulative plastic 50 slow the rate at which the temperature of the blood within the blood bag increases.

The pockets 56 of the insulative plastic 50 are constructed such that the sizes, shapes, and orientations are variable. The size of the pockets 56 can be relatively small or large, and can be defined by density, i.e., the number of pockets per area. The pockets 56 can have a high density, a low density, or a mix of high and low densities. The insulative plastic 50 may have a high pocket density (e.g., many small pockets per area as indicated by reference numeral 62), a low pocket density (e.g., fewer large pockets per area as indicated by reference numeral 64), or any density intermediate thereof (as indicated by reference numeral 66). For example, the insulative plastic 50 may include a pocket density in a range of about 0.05-50 pockets per square centimeter. In other constructions, the insulative plastic 50 can include a pocket density in a range of about 0.005-50 pockets per square centimeter. Further, the insulative plastic 50 can include multiple sections where each section has a unique pocket density. Additionally, it is contemplated that the pockets 56 in the insulative plastic 50 may be arranged such that the pockets 56 are aligned in straight rows and columns. Alternatively, the pockets 56 may be staggered or be randomly dispersed throughout the device. Further, the insulative plastic 50 may include portions such that each portion has a unique pocket orientation. The boundaries may have a variety of dimensions as well. In other words, the space between the pockets 56 may have any suitable dimensions. Additional modifications to the insulative plastic 50 may include long pockets 56 in either the horizontal or vertical direction. Further modifications include increasing the thickness of the insulative plastic 50 as thicker side walls (i.e., the trend line E of Bubble 516 in FIG. 2) reduce heat transfer more efficiently than thinner side walls (i.e., the trend line D of Bubble 316 in FIG. 2).

Further with respect to FIG. 4, the insulative plastic 50 includes a pocket thickness or height. The pockets 50 define a cavity 56′ having a first surface and a second surface such that the pocket thickness may be defined as the distance between the surfaces. In one construction, the pocket thickness is about 8 mm to about 10 mm; however, pocket thickness can range from about 0.5 mm to about 3.0 cm. As described in greater detail below with respect to individual embodiments, the insulative plastic and therefore the pockets define walls of various blood bag insulators. The walls secure and insulate blood bags from unnecessary heat exchange with the surrounding environment. Therefore, the pockets 50, which make up all or a portion of the walls of the insulators and are defined by the pocket thickness, are configured to accommodate a variety of blood bag sizes (i.e., bags ranging from relatively small to large). The pocket thickness is designed such that the walls of the device are capable of accommodating changes in blood bag size (e.g., thickness) as blood is depleted from the bag. In one example, a pocket thickness of 8 mm-10 mm was found to successfully insulate relatively full blood bags of about 350 ml, which may have an approximate thickness of 20 mm, as well as relatively empty blood bags of about 100 ml, which may have an approximate thickness of 7 mm.

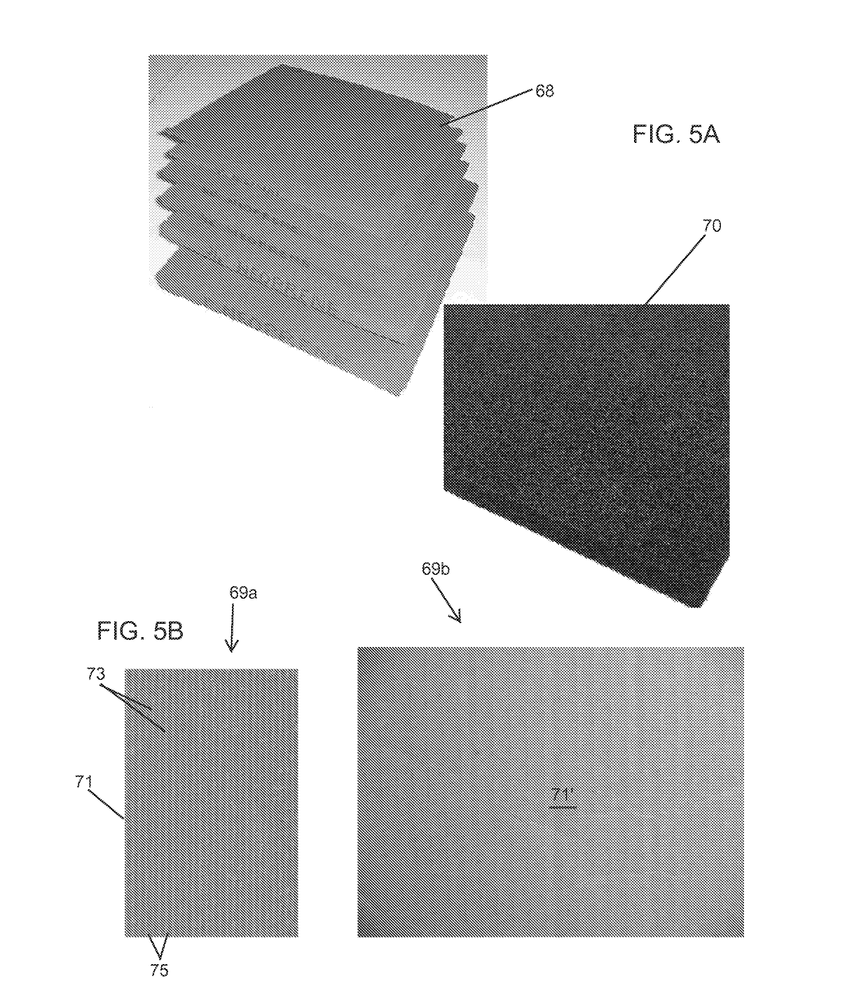

FIGS. 5A and 5B illustrate alternative or auxiliary insulative materials. For example, FIG. 5A illustrates flexible, light-weight and resilient foams 68 or foam-like materials 70 (i.e., polyurethane and neoprene) that also can be used as insulative materials in the device. In addition to their thermal insulation properties, insulative foam 68, 70 of this type may also be waterproof and shock-absorbent. FIG. 5B illustrates that panels 69a, 69b having variable rigidity, thickness, and flexibility may also be used as an insulative material in the device. The panel 69a is constructed from at least one wall 71 having a plurality of ridges 73, with the ridges 73 defining channels or grooves 75 therebetween. The panel 69a includes a smooth surface along the first wall 71 and a rough surface opposite the first wall 71. The panel 69b also includes a second wall 71′ coupled to surfaces of the ridges 73. As such, both sides of the panels 69b include a smooth surface with the ridges secured therebetween. The panels 69a, 69b are constructed from recyclable materials such as cellulose or wood fibers. The panels are constructed to have a low value of thermal conductivity (i.e., rate of heat transfer). The illustrated panels 69a, 69b are merely exemplary and may have any suitable construction (i.e., more or fewer ridges 73 and channels 75 or greater or lesser total thickness and flexibility or more or fewer layers, for example). Additionally, the panels 69a, 69b may be constructed from any suitable materials having a low value of thermal conductivity.

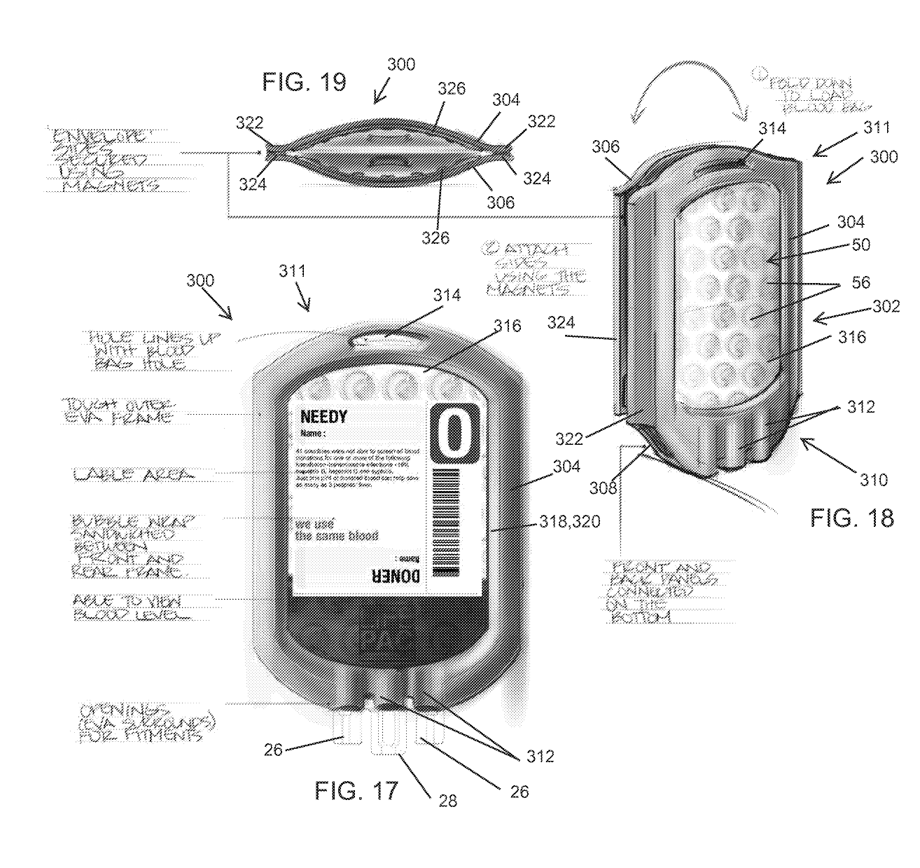

FIGS. 6-47 illustrate a variety of embodiments of blood bag insulation devices that are constructed from one or a combination of the insulated materials described above. FIG. 6 illustrates a first embodiment of the invention for a blood bag insulation device or container 72. The blood bag insulation device 72 includes a body 74 having a first smooth outer wall 76 and second outer wall 78 opposite the first outer wall 76. The second outer wall 78 includes pockets 56 having a staggered configuration and a high density (i.e., more and smaller pockets). In further embodiments, the insulation device 72 may be constructed from insulative plastic 50 having any suitable density, size, shape and orientation of the pockets. An adhesive strip 80 is applied to a first side 82 of the first outer wall 84, which is used to couple the first side 82 to a second side 84 of the first outer side 76. As such, the body 74 may be wrapped around the blood bag 10 leaving access to the ports 26, tubes 28 and hanger-hole 30 while in use.

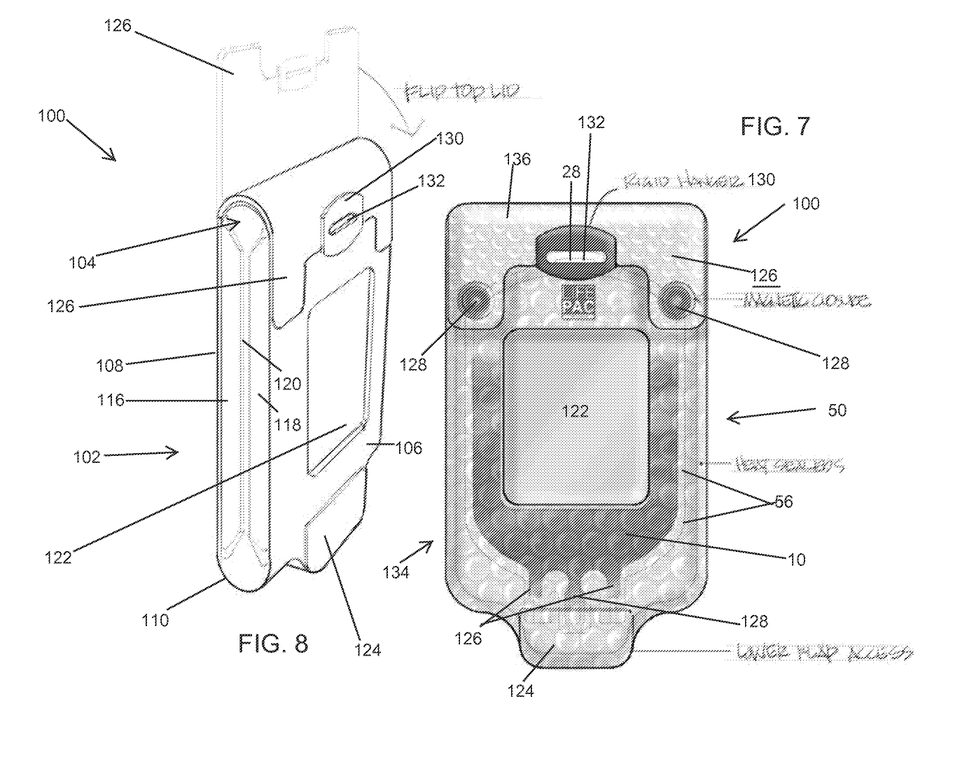

FIGS. 7-8 illustrate a blood bag insulation device 100 or container according to another embodiment of the invention. The blood bag insulation device 100 includes a body 102 including a cavity 104 and having a first outer wall 106 and a second outer wall 108 integrally connected and creating a bottom wall 110 therebetween. The insulation device 100 further includes a first side wall 112 and a second side wall (not shown) extending between the first and second outer walls 106, 108. The first and second walls each include a first portion 116 connected to and moveable relative to a second portion 118 along a pivotable seam 120. The first and second portions 116, 118 allow the insulation device 100 to expand in order to receive the blood bag 10 and contract as blood is used and/or when the insulation device 100 is not in use. At least one of the first or second outer walls 106, 108 includes a window 122 or opening. The window may be flush or recessed with respect to the at least one wall 106, 108. The first outer 106 wall includes an integrally formed bendable or deformable flap 124 and magnets (not shown). The flap 124 enables access and use of all of the ports 26 and tubes 28. The window 122 is formed of clear plastic and ensures the visibility of the label 32 on the blood bag 10. The second outer wall 108 includes an integrally formed, bendable flap 126, which includes magnets 128 and is movable between a first position and a second position. In the first position, the flap 126 is recessed thereby exposing the cavity 104. In the second position, the flap 126 is magnetically coupled to the first outer wall 108. Further embodiments may include alternate suitable fastening mechanisms to couple the flap 126 to the first outer wall 108. The flap 126 includes a hanger 130 constructed of rigid plastic and including a through-hole or hanger-hole 132 for suspending the insulation device 100 from a stand (not shown).

In the embodiment depicted in FIGS. 7-8, a combination of insulative plastics is used including a first insulative plastic 134 and a second insulative plastic 136. The first insulative plastic, which includes the first outer wall 106 and second outer wall 108 except for the flap 126, are constructed from insulative plastic 50 that includes pockets 56 of intermediate size and density and that are in a staggered configuration. The flap 126 is constructed from insulative plastic 50 that includes staggered pockets 50 having a smaller size and a higher density. In further embodiments, the insulation device may be constructed from insulative plastic 50 having any suitable density, size, shape and orientation of the pockets and may have more sections of non-uniform insulative plastic or may have one uniform section. The insulated plastic combination can be transparent to indicate blood levels during use.

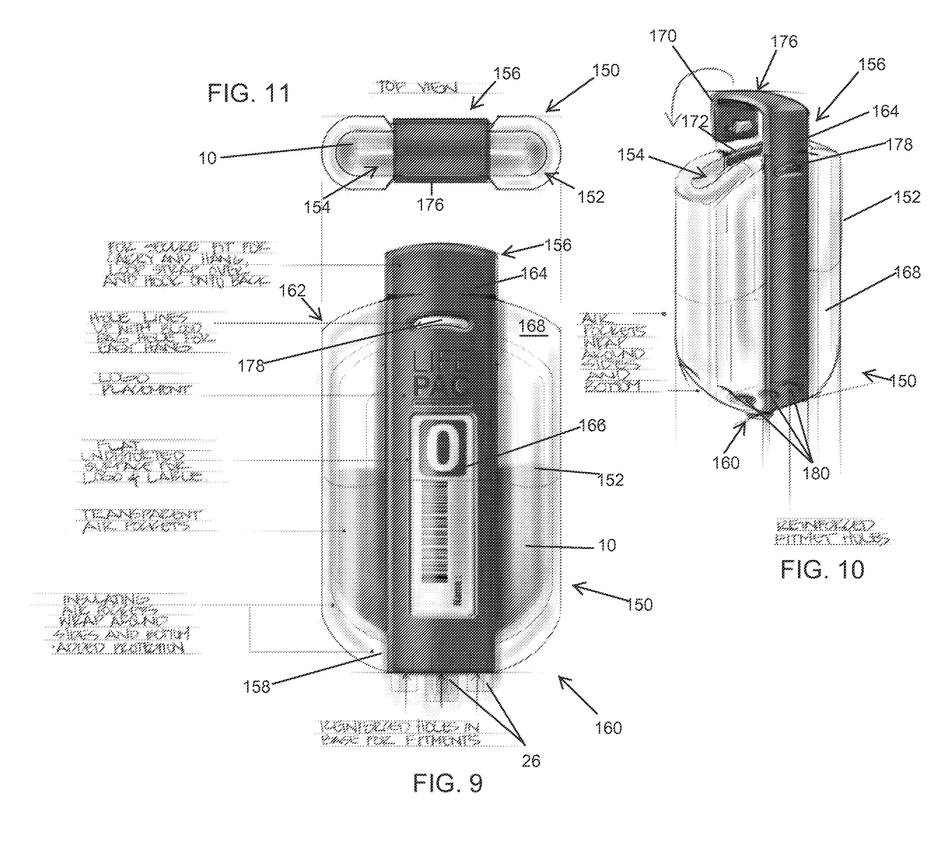

FIGS. 9-11 illustrate a blood bag insulation device 150 or container according to another embodiment of the invention. The blood bag insulation device 150 includes a uniformly constructed outer wall 152 that creates an ovular cavity 154 for receipt of the blood bag 10 therein. The outer wall 152 continuous along its width. A handle or strap 156, which extends longitudinally, is coupled to a portion 118 of the wall 152. The handle 156 is coupled to a second end 160 of the insulation device 150 and extends upwards above a first end 162 of the insulation device 150. A first side 164 of the handle 156, which also includes a label area 166 to indicate the type of blood in use, extends along a first side 168 of the outer wall and a second side 170 of the handle 156 is removably coupled to latch 172 on a second side 174 of the outer wall 152. The first side 164 and the second side 170 of the handle 156 are uniformly constructed thereby creating a u-shaped portion 176 that extends across the cavity 154 at the first end 162 of the insulation device 150. The first side 164 of the handle 156 additionally includes a through-hole 178 that is aligned with the through-hole 30 of the blood bag 10 such that the blood bag 10 and the insulation device 150 may be suspended while in use. The second end 160 of the insulation device 150 includes a plurality of reinforced holes that receive and allow access to the ports 26 and tubes 28 of the blood bag 10.

In the embodiment depicted in FIGS. 9-11, the outer wall 152 of the insulation device 150 is constructed from insulative plastic 50 having large, transparent pockets and therefore, has a low pocket density. In further embodiments, the insulation device may be constructed from insulative plastic having any suitable density, size, shape and orientation of the pockets. The handle 156 and latch 172 are constructed from rigid plastic, although other suitable materials may be utilized. It is also contemplated that the handle may be color-coded to indicate the type of blood in use.

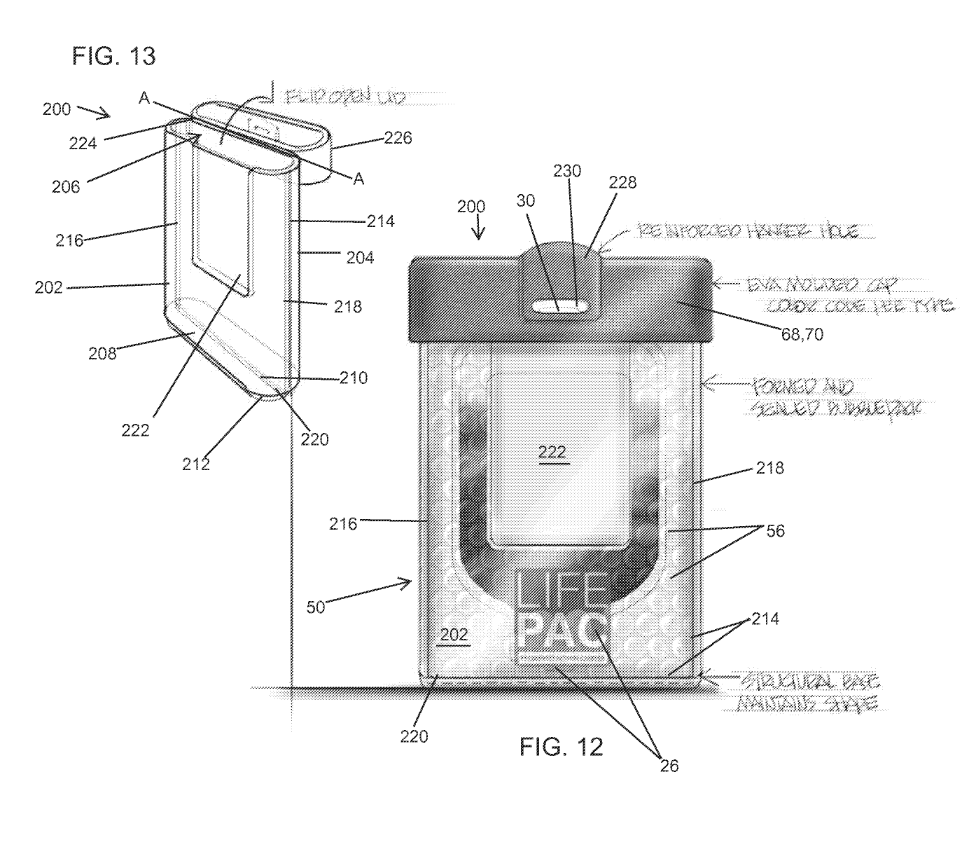

FIGS. 12-13 illustrate a blood bag insulation device 200 or container according to another embodiment of the invention. The blood bag insulation device 200 includes a first outer wall 202 and a second outer wall 204 integrally connected and creating a cavity 206 therebetween. The cavity is further enclosed by a bottom wall 208 having an aperture 210 that exposes the ports 26 and tubes 28 of the blood bag 10. The bottom wall 208 includes a recessed lip 212. Structure is given to the insulation device 200 by a base or frame 204 that includes first 216, second 218, and third 220 edges. The frame 214 helps the insulation device 200 maintain its shape thereby imparting a more defined structure. The first outer wall 202 includes a window 222, preferably formed from a transparent, low density plastic although any suitable material that prevents heat transfer is acceptable, which allows the label 32 of the blood bag 10 to be easily visible. The second outer wall 204 includes a hinge 224 that couples the second outer wall 204 to a lid or closure member 226. The lid is rotatable about an axis A to allow access to the cavity 206 that receives the blood bag 10. In a first position, the lid 226 is open exposing the cavity 206 and in a second position, the lid 226 covers the cavity 206 thereby sealing the cavity 206 from ambient air. The lid 226 includes a rigid portion 228 that includes a through-hole 230; the rigid portion 228 is reinforced for suspending the blood bag 10 and insulation device during use.

In the embodiment depicted in FIGS. 12-13, insulation device 200 is constructed from insulative plastic 50 having an intermediate density of round pockets where the pockets 56 have an intermediate size and are arranged in a staggered configuration. It is contemplated that the density, size, shape and orientation of the pockets may vary. Further, the lid 226 is formed from insulative foam 68, 70 described above with respect to FIG. 3. The color of the foam indicates the type of blood that is contained within the blood bag 10; the color of the foam is determined by the regulatory standards stipulated by the FDA.

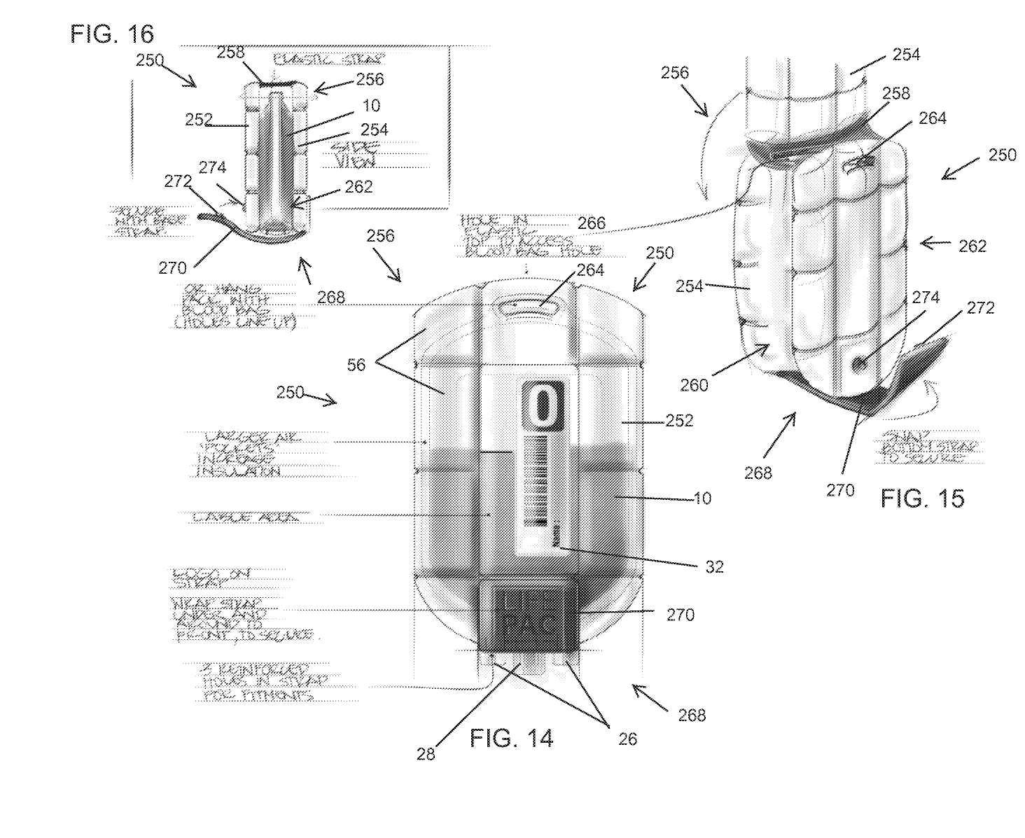

FIGS. 14-16 illustrate a blood bag insulation device 250 or container according to another embodiment of the invention. The blood bag insulation device 250 includes a first outer wall 252 and a second outer wall 254 integrally connected on a first end 256 by an elastic strap 258. The insulation device 250 does not include side walls that connect the first and second outer wall 252, 254 and therefore, includes openings along a first side 260 and a second side 262 when in use. The first and second outer walls 252, 254 each include through-holes 264 that are aligned, and when in use, the through-holes 264 are also aligned with the through-hole 28 of the blood bag 10 such that the blood bag 10 is capable of being suspended from a stand (not shown). Alternatively, a through-hole 256 in the elastic strap 258 may receive the through-hole 28 of the blood bag 10. The elastic strap 258 allows the first and second outer walls 252, 254 to move relative to one another. At a second end 268 of the insulation device 250, a base strap or closure member 270 is included on the second outer wall 254 and removably coupled to the first outer wall 252. The base strap 270 includes an aperture 272 that receives a projection 274 included on the first outer wall 252 of the insulation device 250. The base strap 270 further includes a plurality of centrally-located and reinforced holes that receive and support the ports 26 and tubes 28 of the blood bag 10. The base strap 270 is unsecured in a first position such that the blood bag 10 is insertable and removable between the first and second outer walls 252, 254. The base strap 270 is secured to the projection 274 when in a second position such that the blood bag 10 is securely and tightly retained between the first and second outer walls 252, 254. At least one of the first and second outer walls 252, 254 includes a label area 276 that is constructed of low-density plastic.

In the embodiment depicted in FIGS. 14-16, the first and second outer walls 252, 254 are constructed from insulative plastic 50 having large pockets 56 and are therefore characterized as low density. In further embodiments, the insulation device 250 may be constructed from insulative plastic 50 having any suitable density, size, shape and orientation of the pockets. It is also contemplated that either or both of the elastic strap 258 and the base strap may be color-coded to indicate the type of blood in use.

FIGS. 17-19 illustrate a blood bag insulation device 300 or container according to another embodiment of the invention. The blood bag insulation device 300 includes a body 302 having a first outer wall 304 and a second outer wall 306. Panels 308 extend between the first outer wall 302 and the second outer wall 304 at a second end 310 of the insulation device thereby connecting the first outer wall 304 to the second outer wall 306. The second end includes a plurality of recesses 312 and a first end 311 includes aligned through-holes 314 such that when in use, the recesses 312 accommodate the ports 26 and tubes 28 of the blood bag 10 and the through-holes 314 are in alignment with the through-hole 20 in the blood bag 10. At least one of the first and second outer walls 304, 306 includes a window 316, which enables visibility of the label 32 and is constructed from any suitable plastic, configured to create a frame 318 that extends about a perimeter 320 of the window 316. The window 316 may be flush or recessed with respect to the at least one of the first and second outer walls 304, 306. Each of the first and second outer walls 304, 306 includes a first and a second lip 322, 324 that extends from the body. The lips 322, 324 include magnets (not shown) for coupling the first outer wall 304 to the second outer wall 306. Prior to inserting the blood bag 10, the lips 322, 324 are engaged. To insert the blood bag 10, the lips 322, 324 are pried apart to disengage the magnetic coupling such that the first and second outer walls 304. 306 are folded down about the panels 308 at the second end 310. Once the blood bag 10 has been appropriately placed, the first and second outer walls 304, 306 are folded back up and aligned to re-engage the magnetic coupling thereby securing the first and second outer walls 304, 306 with the blood bag 10 therebetween. In this configuration, the through-holes 30, 314 are in alignment such that the blood bag 10 and insulation device may be suspended for use.

In the embodiment depicted in FIGS. 17-19, the body 302 including the lips 322, 324 of each of the first and second outer walls 304, 306 are constructed from insulative foam 68, 70. The insulative foam imparts a rigidity, which gives the body 302 a more distinct shape. It is contemplated that the insulative foam may be color-coded to indicate the type of blood in use. Further, the first and second outer walls 304, 306, excluding the lips 322, 324, are lined with insulative plastic 50 on interior sides 326. The insulative plastic 50 is transparent so that the blood levels during use are visible. Additionally, the insulative material is constructed with pockets 56 that are configured in a staggered orientation and that are intermediate in size such that the density of pockets is also intermediate. It is contemplated that further embodiments may include any suitable density, size, shape and orientation of the pockets.

FIGS. 20-22 illustrate a blood bag insulation device 350 or container according to another embodiment of the invention. The blood bag insulation device 350 includes a first end and a second end 350, 352 and including a body 356 defining a cavity 358. The body 356 includes a first outer wall 360 and a second outer wall 362 coupled on the second end 354. The body further includes a first side wall 366 and a second side wall 368 secured between the first and second outer walls 360, 362. The first and second side walls 36, 362 are expandable and collapsible. The first end 352 is open and exposes the cavity 358. The first and second outer walls 360, 362 include aligned through-holes 370 at the first end 352 and a plurality of recesses 372 at the second end 354. The blood bag 10 slides into the cavity 358 during use. The recesses 372 receive the ports 28 and tubes 30 and the through-holes 30, 370 align in order to suspend the blood bag 10 and insulation device 350 during use. The elasticity of the walls 366, 368 allows the cavity 358 to expand to accommodate the blood bag 10 when full, and as the blood is used and the volume decreases, the walls 366, 368 contract such that the blood bag 10 is tightly secured between the first and second outer walls 360, 362. At least one of the first and second outer walls 360, 362 includes a label 374 area to designate the type of blood in use. The first and second outer walls 360, 362 also include openings 376 configured such that the blood level is visible throughout use of the blood bag 10. In the illustrated embodiment, the shapes of the openings 376 are hexagonal such that the openings 376 are arranged in a honeycomb-like orientation. In further embodiments, the openings 376 may include any suitable shape and configuration. The openings 376 include a plastic film 378 that prevents heat transfer.

In the embodiment depicted in FIGS. 20-22, the first and second outer walls 360, 362 are constructed from opaque insulative foam 68, 70. Additionally, any or all of the openings 376 may be clear in order to make blood levels visible. It is contemplated that in further embodiments, either or both of the first and second outer walls 360, 362 may be color-coded to indicate the type of blood that is in use.

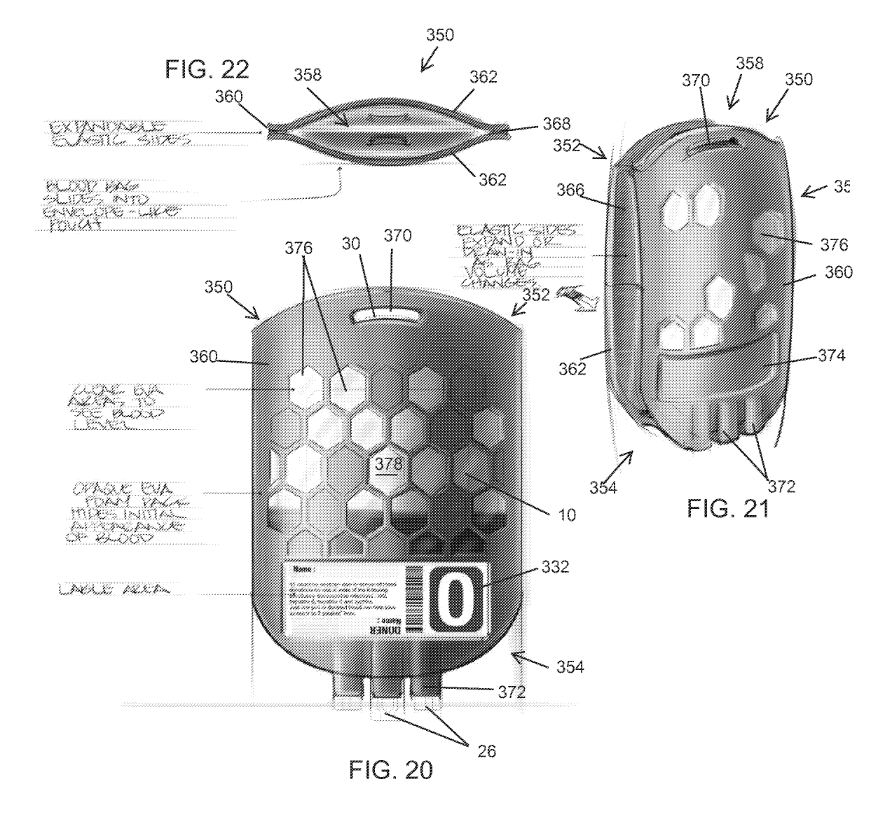

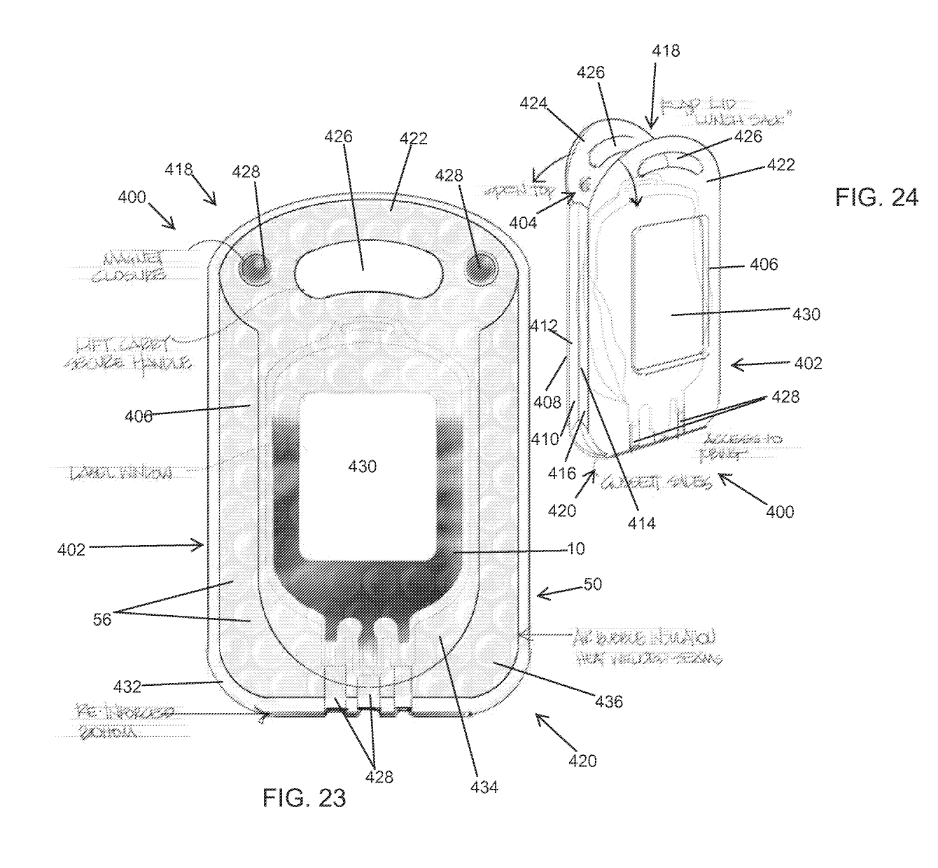

FIGS. 23-24 illustrate a blood bag insulation device 400 or container according to another embodiment of the invention. The blood bag insulation device 400 includes a body 402 that defines a cavity 404. The body 402 includes a first outer wall 406 and a second outer wall 408 having collapsible walls 410 secured therebetween. The collapsible walls 410 include a first portion 412 coupled to a second portion 414 at a pivotable seam 416 such that that first 412 and second 414 portions are movable (i.e., to be expanded or contracted) relative to one another along the seam 416. The expandable and collapsible walls 410 extend between a first end 418 and a second end 420 of the insulation device 400. First and second handles 422, 424 are integrally formed with the first and second outer walls 406, 408, respectively, at the first end 418. The handles 422, 424 include magnets and aligned apertures 426. The magnets 428 couple the first handle 422 to the second handle 424 thereby creating a secure handle with which to transport the blood bag 10 and also enable the blood bag 10 and insulation device 400 to be suspended when in use. The second end 418 includes a plurality of recesses 428 for receiving the ports 26 and tubes 28. At least one of the first and second outer walls 406, 408 includes a label area 430 to designate the type of blood in use. In the illustrated embodiment the labeled area 430 is a window that includes a plastic film to prevent heat transfer. In further embodiments, the label area may be a recess that receives a removable label.

In the embodiment depicted in FIGS. 23-24, the first and second outer walls 406, 408 are constructed from insulative plastic 50 configured to have an intermediate density of average-sized pockets 56 oriented in a staggered configuration. The insulative plastic extends from the second end to the handle on each of the first and second outer walls. An outer lip that extends about the perimeters of each of the walls reinforces the insulative plastic via heat-welded seams 432. The seams may be color-coded to indicate the type of blood in use. In the illustrated embodiment, the first and second walls include insulative plastic that is of uniform pocket size and density. In further embodiments, the first and second walls may include insulative plastic with non-uniform density. For example, a central portion 434 of each of the first and second walls may have larger or smaller pockets relative to the size and density of the pockets on peripheral portions 436 of the walls. Additionally, the handle may have a unique insulative plastic configuration. In further embodiments, the insulation device may be constructed from insulative plastic having any suitable density, size, shape and orientation of the pockets.

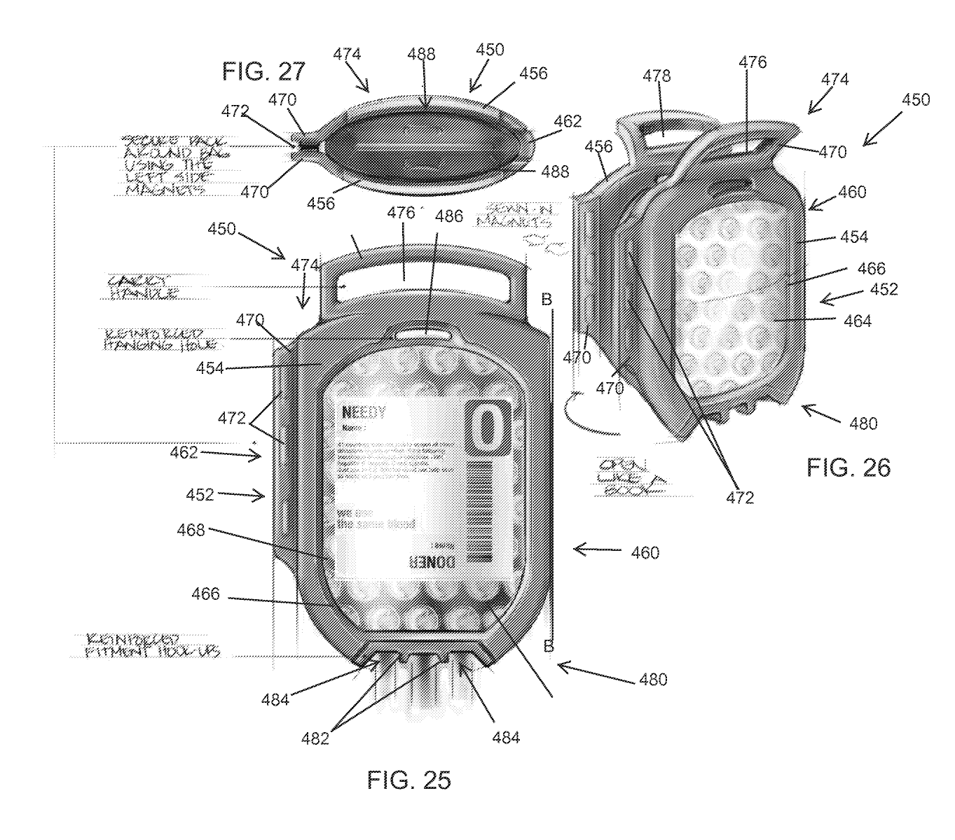

FIGS. 25-27 illustrate a blood bag insulation device 450 or container according to another embodiment of the invention. The blood bag insulation device 450 includes a body 452 having a first outer wall 454 and a second outer wall 456 each having a first side 458 and a second side 460. The first outer wall 454 and the second outer wall 456 are connected to and pivotal about a hinge 462 on the second side 460 of insulation device 450. At least one of the first and second outer walls 454, 456 includes a window or label area 464, which enables visibility of the label 32 and is constructed from any suitable plastic, configured to create a frame 466 that extends about a perimeter 488 of the window 464. The window 464 may be flush or recessed with respect to the at least one of the first and second outer walls 454, 456. Each of the first and second outer walls 454, 456 includes a lip or edge 470 that extends from the first side 458. The lips 470 include magnets 472 for coupling the first outer wall 454 to the second outer wall 456. A top end 474 of the insulation device 450 includes a handle 476 integrally formed with each of the first and second outer walls 454, 456; the handles 476 include an aperture 478 from transporting the blood bag 10. A bottom end 448 of the insulation device 450 includes a plurality of ridges 482 that define recesses or reinforced portions 484 of each of the first and second outer walls 454, 456 for receiving and supporting the ports 26 and tubes 28 of the blood bags 10 when in use. Adjacent to and below the handles are aligned through-holes 486. When not magnetically coupled, the first and second outer walls move relative to each other about an axis B. When the first and second walls are magnetically coupled, the blood bag 10 is secured between the first and second outer walls 454, 456.

In the embodiment depicted in FIGS. 25-27, the first and second outer walls 454, 456, including the lips 470 and handles 476, are constructed from insulative foam 68, 70. The first and second outer walls are reinforced with insulative plastic 50 on an interior side 488. In the illustrated embodiment, the insulative plastic pockets 56 are in a staggered configuration and are larger in size and therefore, the insulative plastic has a lower density of pockets. In further embodiments, the insulation device 450 may be constructed from insulative plastic having any suitable density, size, shape and orientation of the pockets. It is contemplated that in further embodiments, either or both of the first and second outer walls may be color-coded to indicate the type of blood that is in use.

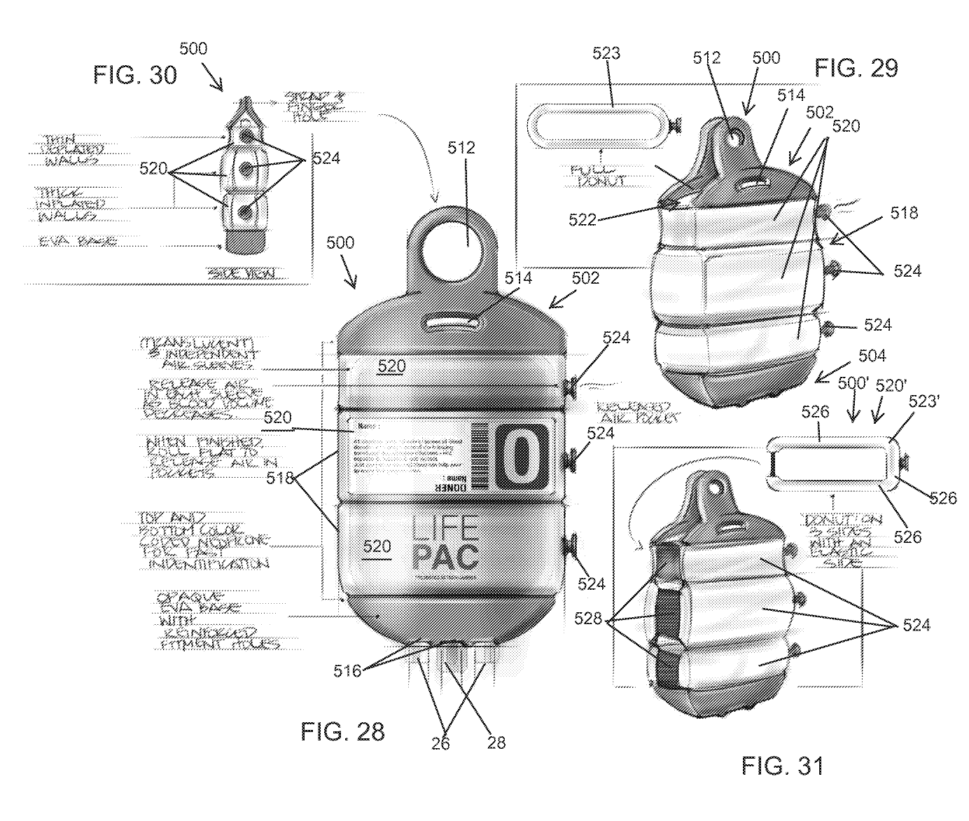

FIGS. 28-30 illustrate a blood bag insulation device 500 or container according to another embodiment of the invention. The blood bag insulation device 500 includes a first end 502 and a second end 504 having an intermediate portion 506 therebetween. The first end 502 includes a first side wall 508 and a second side wall 510, each of which each include a finger hole 512 and a through-hole 514. The second end 504 uniformly formed and is bowl-shaped. The second end 504 includes recesses 516 or apertures that accommodate the ports 26 and tubes 28 of the blood bag 10 when in use. The intermediate portion 518 includes three ovular or donut-shaped sections 520 that create a central cavity 522 from a uniform wall 523. In further embodiments, there may be more or less ovular sections. Each section 520 is a large and extends horizontally; the sections 520 are stacked vertically and have a vent 524 on a first side. When not in use and with the vents 524 open, the insulation device 500 may be rolled up to release the contents of the sections 520 (i.e., for the insulation device 500 to be stored). In preparation for use, the insulation device 500 is unrolled so that each section 520 inflates. It is contemplated that the sections 520 may inflate manually or automatically. The cavity 522 is constructed to accommodate a full blood bag 10 and the sections 520 may be inflated according to the size of the blood bag 10 in use such that there is no clearance between the blood bag 10 and the cavity 522. As the blood is used and the bag 10 is emptied, the sections 520 may be deflated one by one to eliminate clearance (not shown) that is introduced as the blood level drops. The sections 520 may be deflated either manually or automatically. FIG. 31 illustrates a variation of embodiment illustrated in FIGS. 28-30. The cavity is created by ovular sections 520 having three inflatable sides 526 and one elastic wall 528. The elastic wall 528 helps to accommodate bags 10 of different sizes (i.e., from different manufacturers etc.).

In the embodiment depicted in FIGS. 28-31, the first and second ends 502, 504 are constructed from insulative foam 68, 70. It is contemplated the first and second ends 502, 504 may be color-coded to indicate the type of blood that is in use. The sections 520 are constructed of insulative plastic 50 constructed from large horizontally extending pockets 56. In further embodiments, the insulation device may be constructed from insulative plastic having any suitable density, size, shape and orientation of the pockets. The sections are transparent in order to see both the label 32 of the blood bag 10 and the blood level over the course of use.

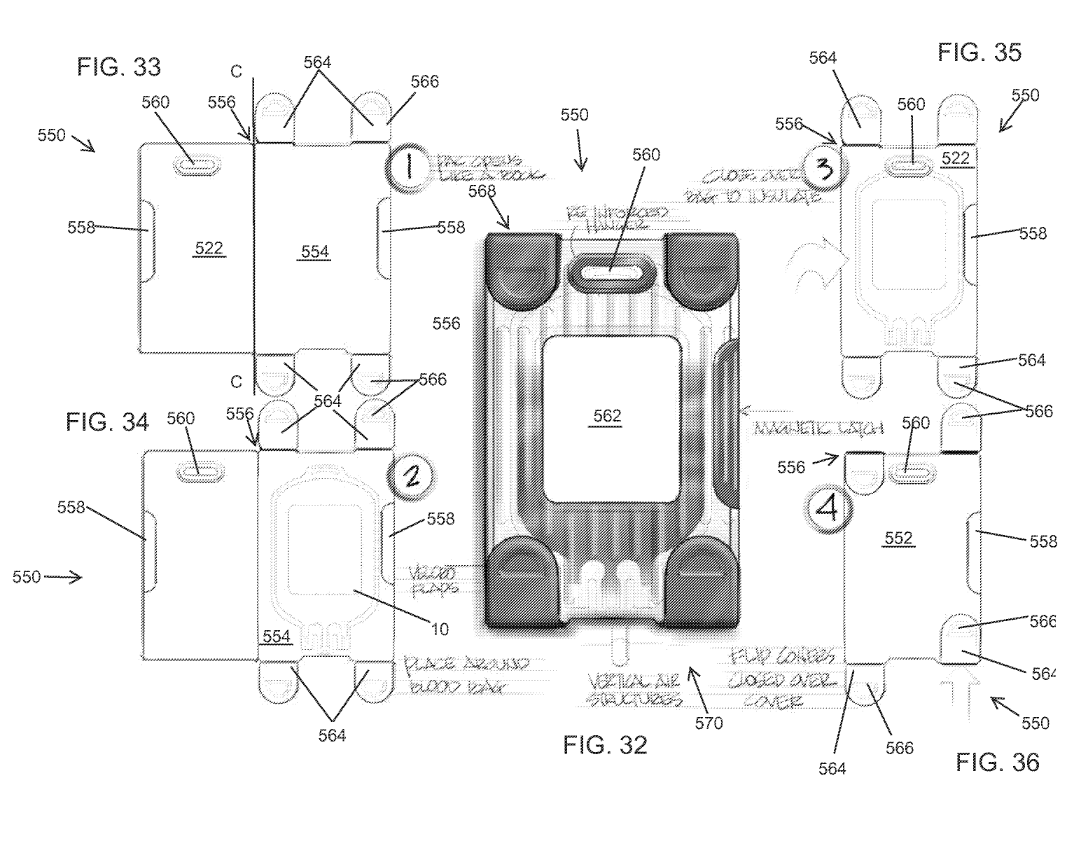

FIGS. 32-36 illustrate a blood bag insulation device 550 or container according to another embodiment of the invention. The blood bag insulation device 550 includes a first outer wall 552 and a second outer wall 554 moveable relative to one another via a hinge 556. Each of the first and second outer walls 552, 554 includes latches 558 that include magnets (not shown) as well as aligned and reinforced through-holes 560. The first outer wall 552 includes a transparent window 562 constructed from plastic that slows heat transfer. The second outer wall 554 includes a plurality of securement straps 564. The securement straps 564 include a hook and loop attachment mechanism 566 that is mated with complimentary material (not shown) on the first outer wall 552. In the open position (FIG. 32), the first and second outer walls 552, 554 are oriented at a maximum angle of 180° relative to one another. While in the open position, the blood bag 10 is placed against the second outer wall (FIG. 34). The first outer wall 552 is rotated about the axis C to cover the blood bag 10 thereby magnetically coupling the latches 558 and therefore, the first outer wall 552 to the second outer wall 554 with the blood bag 10 secured therebetween (FIG. 35). Subsequently, the securement straps 564 are secured to the complimentary material on the first outer wall 552 (FIG. 36). When the blood bag 10 is installed, the through-holes 30, 560 align at a first end 568 of the insulation device 550 and the ports 26 and tubes 28 are accessible via an opening (not shown) at a second end of the insulation device 550 (FIG. 32).

In the embodiment depicted in FIGS. 32-36, the first and second outer walls 552, 554 are constructed from insulative plastic 50 having narrow pockets 56 extending vertically. In further embodiments, the insulation device 550 may be constructed from insulative plastic 50 having any suitable density, size, shape and orientation of the pockets. Additionally, the securement straps 564 and/or the latch 558 may be color-coded to indicate the type of blood that is in use.

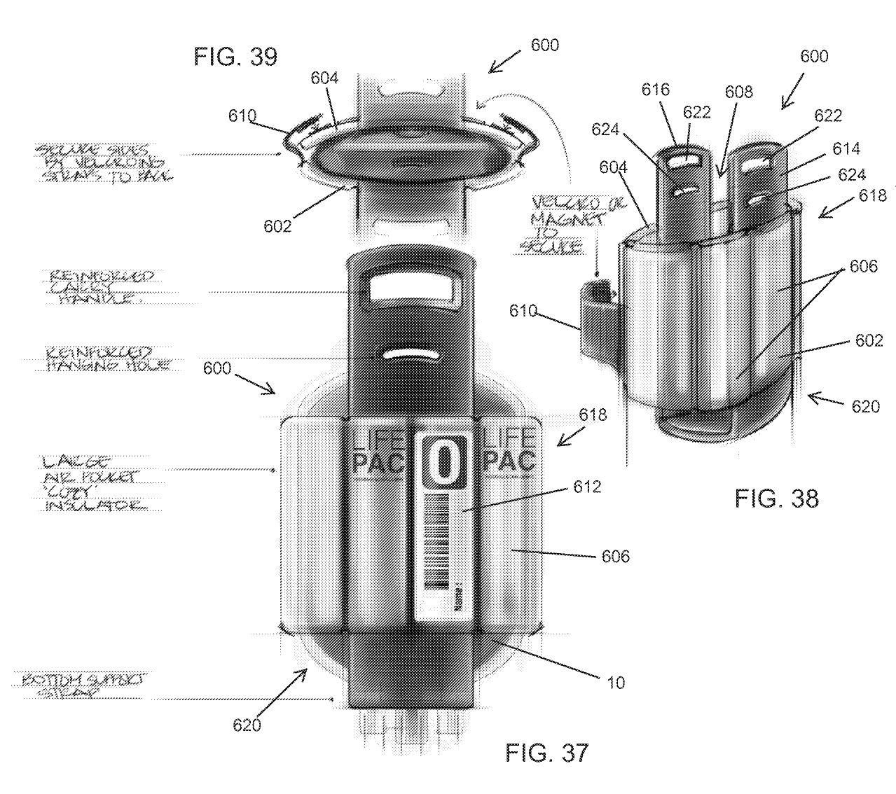

FIGS. 37-39 illustrate a blood bag insulation device 600 or container according to another embodiment of the invention. The blood bag insulation device 600 includes a first outer wall 602 and a second outer wall 604, each having parcels 606 oriented in a vertical direction and coupled horizontally and creating a cavity 608 or opening therebetween. The first outer wall 602 is removably secured to the second outer wall 604 by securement straps or closure members 610. The securement straps 610 are coupled to the first outer wall 602 and include hook and loop type fasteners that mate with hook and loop type fasteners included on the second outer wall 604. The securement straps 610 enable the first and second outer walls 602, 604 to control how tightly the blood bag 10 is secured therebetween. At least one of the first and second outer walls 602, 604 includes a label area 612 for displaying the type of blood in use. The first and second outer walls 602, 604 include a first handle 614 and a second handle 616, respectively. The handles 614, 616 are reinforced and extend from a first end 618 to a second end 620 of the insulation device 600. The first and second handles 614, 616 are integrally formed such that they form one u-shaped body. In further embodiments, the first and second handles 614, 616 could be formed separately and coupled to one another. The first and second outer walls 602, 604 may be either permanently coupled to the first and second handles 614, 616 or the first and second outer walls 602, 604 may be removeably coupled to the first and second handles 614, 616, depending on the embodiment. On the first end 618, each of the first and second carrying handles 614, 616 includes aligned apertures 622 used to transport the blood bag 10 and aligned apertures 624 that also align with the through-hole 30 of the blood bag 10 for suspension while in use. The second end 620 of the insulation device 600 (i.e., where the first and second handles are joined) includes a plurality of reinforced holes (not shown) that receives the ports 26 and tubes 28 of the blood bag 10. In the illustrated embodiment, the insulation device 600 only covers a central portion of the blood bag 10 thereby leaving peripheral portions of the blood bag 10 exposed on either side. In further embodiments the insulation device 600 may have greater or smaller dimensions such that more or less of the blood bag 10 is enveloped.

In the embodiment depicted in FIGS. 37-39, the first and second outer walls 602, 604 are constructed from insulative plastic 50 formed with large vertically extending pockets 56 and therefore, have a low pocket density. In further embodiments, the insulation device may be constructed from insulative plastic having any suitable density, size, shape and orientation of the pockets. The first and second handles 614, 616 are constructed from rigid plastic, in the illustrated embodiment, but in further embodiments may be constructed from any suitable material. It is also contemplated that the first and second handles 614, 616 may be color-coded to indicate the type of blood that is in use.

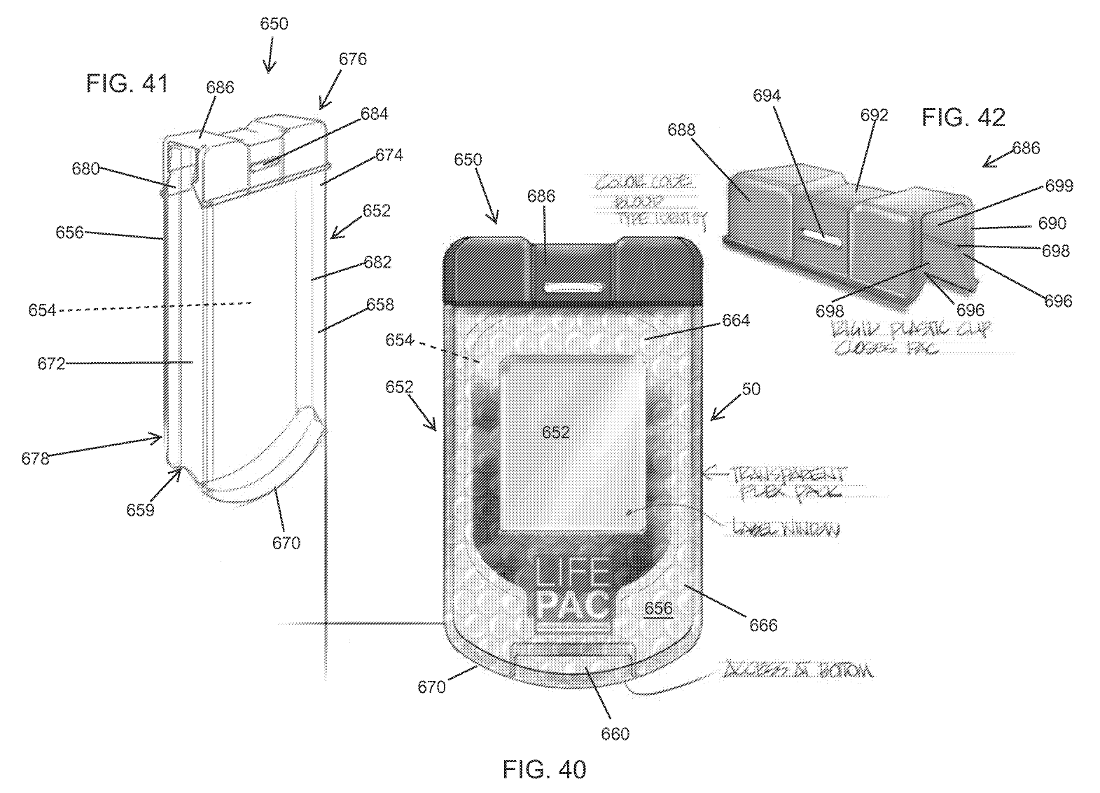

FIGS. 40-42 illustrate a blood bag insulation device 650 or container according to another embodiment of the invention. The blood bag insulation device 650 includes a body 652 including a cavity 654 and having a first outer wall 656 and a second outer wall 658 integrally connected a bottom wall 660. The insulation device 650 further includes a first side wall 672 and a second side wall 674 extending between the first outer wall 656 and the second outer wall 658. The insulation device 650 includes a first end 676 and a second end 678. The first end 676 of each outer wall 656, 658 includes a ridge 680 that extends from a main portion 682 and includes a through-hole 684. The blood bag 10 is inserted into the cavity 654 in preparation for use. Once inserted, a cover or lid 686 is placed over the cavity 654. The cover 686 includes a first cover wall 688, a second cover wall 690, and a third cover wall 692 extending therebetween. The first and second cover walls 688, 690 include aligned through-holes 694. Further, each of the first and second cover walls 688, 690 includes a projection 696 that defines a lip 698 on a first side of each cover wall. The lip 698 engages the ridge 680 on the first end of the insulation device 650 and is slideable along the ridge 680 between the first and second walls 672, 674 of the insulation device 650. When the lid 686 is in use, the through-holes 694 of the lid 686 align with the through-holes 684 of the insulation device 650 and the blood bag 10 such that the blood bag 10 and insulation device 650 may be suspended during use. The second end 678 of the first wall 656 is shorter than the second end 678 of the second wall 658 and therefore, the first and second side walls 656, 658 are stepped as indicated at reference numeral 659. The second end 678 of the first outer wall 656 also includes an opening 660 or recess that allows access to the tubes 26 and ports 28. At least one of the first and second outer walls 656, 658 includes a label area 662 to designate the type of blood in use.

In the embodiment depicted in FIGS. 40-42, the first and second outer walls 656, 658 are constructed from insulative plastic 50 configured to have an intermediate density of average-sized pockets oriented in a staggered configuration. In the illustrated embodiment, the first and second walls include insulative plastic that is of uniform pocket size and density. In further embodiments, the first and second walls may include insulative plastic with non-uniform density. For example, a central portion 664 of each of the first and second walls may have larger or smaller pockets relative to the size and density of the pockets on peripheral portions 666 of the walls. In further embodiments, the insulation device may be constructed from insulative plastic having any suitable density, size, shape and orientation of the pockets. The lid 686 is constructed from a rigid plastic and is color-coded to indicate the type of blood being used. Alternative indicia may be indented into the plastic when molded.

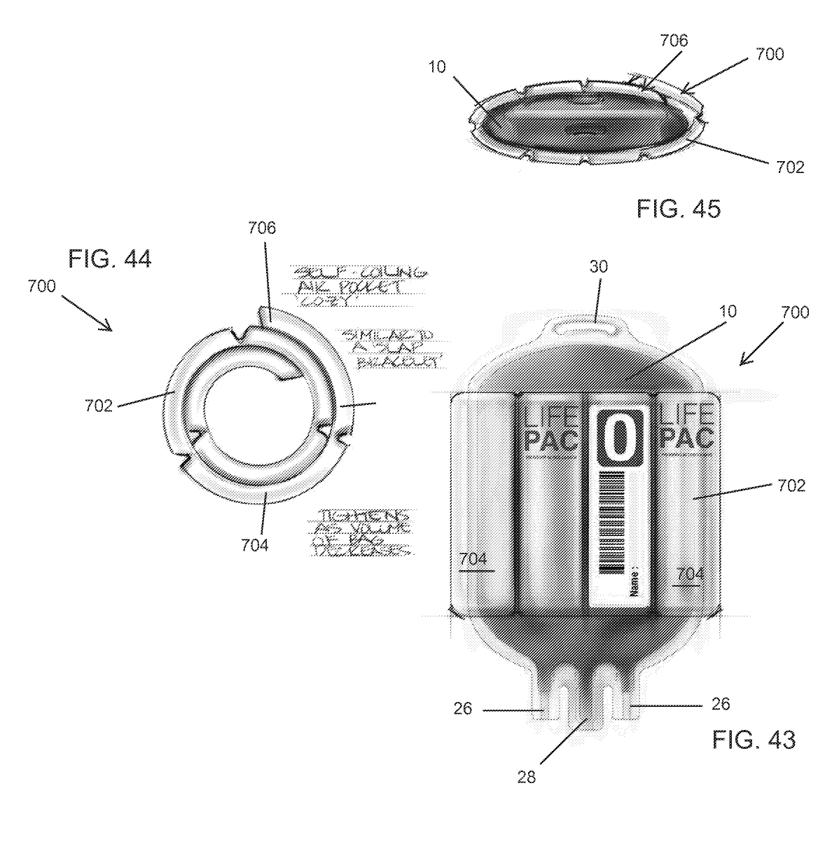

FIGS. 43-45 illustrate a blood bag insulation device 700 or container according to another embodiment of the invention. The blood bag insulation device 700 includes self-coiling body 702 including a plurality of pockets 704 oriented vertically. In a first position (not shown), the body 702 exemplifies a rectangular body with several adjacent pockets. In a second position, the rectangular body coils about a portion of the blood bag 10. The body 702 is sized such that when wrapped about the blood bag 10 there is an excess portion 706 such that body overlaps itself. Additionally, the excess portion 706 is slidable relative to the relative to the body such that as the blood is depleted from the bag, the body tightens about the blood bag 10. In the illustrated embodiment, the insulation device 700 only covers a central portion of the blood bag 10 thereby leaving the through-hole 30 and the ports 26 and tubes 28 exposed on either side. In further embodiments the body 702 may have greater or smaller dimensions such that more or less of the blood bag 10 is enveloped in the insulation device 700.

In the embodiment depicted in FIGS. 43-45, the rectangular body 702 is constructed from insulative plastic 50 having large, vertically oriented pockets 56. In further embodiments, the insulation device 700 may be constructed from insulative plastic having any suitable density, size, shape and orientation of the pockets. In the illustrated embodiments, the body is rectangular but further embodiments may include bodies of any suitable shape.

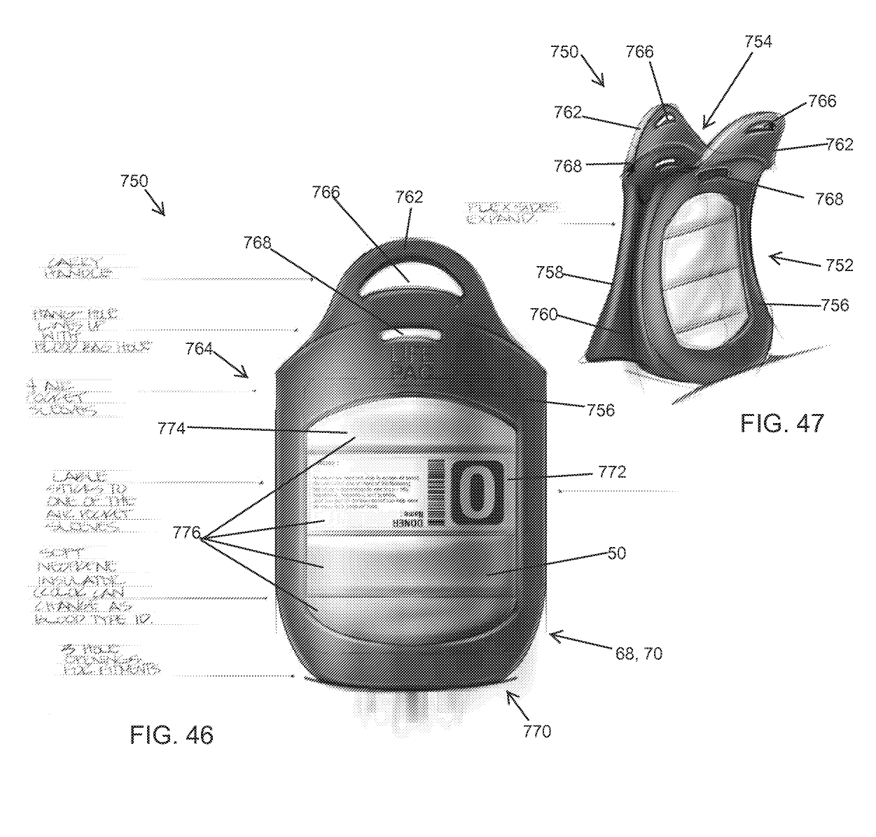

FIGS. 46-47 illustrate a blood bag insulation device 750 or container according to another embodiment of the invention. The blood bag insulation device 750 includes a body 752 defining a cavity 754. The body 752 includes a first outer wall 756 and a second outer wall 758 having a first side wall 760 and a second side wall (not shown) therebetween. The first and second side walls 756, 758 are collapsible and expandable to accommodate the blood bag 10. A handle 762 projects upwards from a first end 764 of each of the first and second outer walls 756, 758 and includes an aperture 766 for creating a carrying handle. The first end 764 of each of the first and second outer walls 756-758 also includes aligned through-holes 768 configured to align with the through-hole 30 of the blood bag 10. A plurality of openings (not shown) is included at a second end 770 of the insulation device 750 and allows access to the ports 26 and 28 tubes of the blood bag 10 when in use. At least one of the first and second outer walls 756, 758 includes a label area 772, which is constructed from plastic that reduces heat transfer, that is suitable for label attachment. Additionally, at least one of the first and second outer walls 456, 758 includes a central portion 774 configured with four horizontal sections 776. Each section 776 extends horizontally; the sections 776 are stacked vertically. In further embodiments there may be greater or fewer sections 776 that make up the central portion of the at least one of the first and second outer walls.

In the embodiment depicted in FIGS. 46-47, the first and second outer walls 756, 758 and the first 760 and second (not shown) side walls are constructed from insulative foam 68, 70. The sections are constructed of insulative plastic 50 having large horizontally extending pockets and therefore, the insulative plastic in the illustrative embodiment has a low pocket density. Further embodiments, may include any suitable density, size, shape and orientation of the pockets. The sections are transparent in order to see both the label 32 of the blood bag 10 and the blood level over the course of use. It is contemplated the body may be color-coded to indicate the type of blood that is in use.

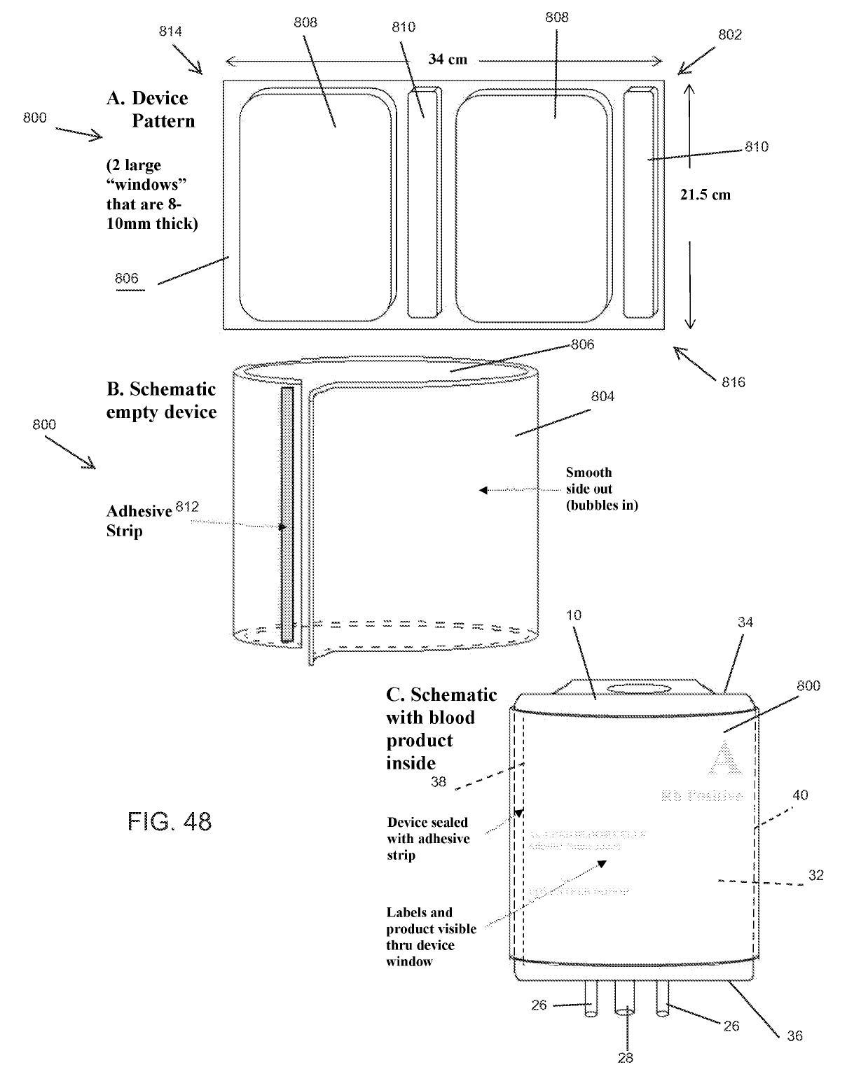

FIG. 48 illustrates another embodiment of the invention for a blood bag insulation device 800. The blood bag insulation device 800 includes a body 802 having a first smooth wall 804 and second wall 806 opposite the first wall 804. The second wall 806 includes large pockets 808 and small pockets 810. At least the pockets 808 are transparent and serve as viewing windows such that blood bag labels 32 are visible through the device 800. An adhesive strip 812 is applied to a first side 814 of the first wall 804, which is used to couple the first side 814 to a second side 816 of the first wall 804. As such, the body 802 may be wrapped around the blood bag 10 leaving access to the ports 26, tubes 28 and hanger-hole 30 while in use. When assembled to surround the blood bag 10, the insulation device 800 is constructed such that the large pockets 808 overlay blood bag labels, while the small pockets 810 overlay first and second side walls 38, 40 of the blood bag 10. In the illustrated embodiment, the insulation device 800 has a low pocket density as there are only four air-filled pockets. In further embodiments, the insulation device 800 may be constructed from insulative plastic 50 having any suitable density, size, shape and orientation of the pockets. For example, the large pockets 808 may take up less surface area such that surrounding surface area may be constructed from insulative plastic 50 having any suitable pocket density.

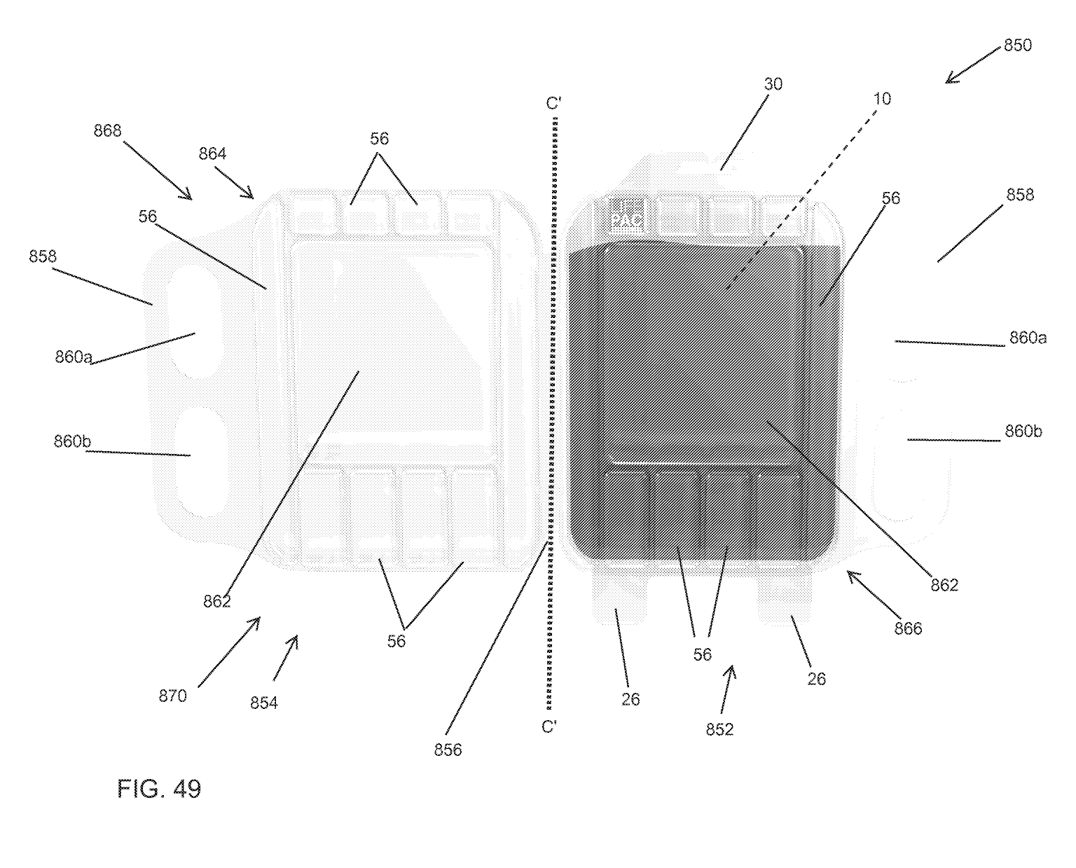

FIG. 49 illustrates a blood bag insulation device 850 or container according to another embodiment of the invention. The blood bag insulation device 850 is constructed from insulative plastic 50 including a first wall 852 and a second wall 854 moveable relative to one another via a hinge 856. Each of the first and second walls 852, 854 includes an inside surface and an outside surface with pockets uniquely arranged. The first and second walls 852, 854 each include a first portion and a second portion 858 that extends from the first portion. The second portion 858 includes first and second apertures 860a, 860b extending therethrough. At least one of the first or second walls 852, 854 includes a transparent window 862 for ease of reading the label on the blood bag. The transparent window 862 can be constructed from plastic that slows heat transfer.

The device 850 also includes an adhesive strip that extends along at least a portion of an outer perimeter 864 of one of the first or second walls 852, 854. The adhesive strip is configured to adhere or bond with a corresponding portion of the other wall 852, 854 thereby securing the blood bag 10 therebetween. Further embodiments may include other suitable bonding means. It is also contemplated that the device 850 may include auxiliary means of securing the first and second walls 852, 854 to one another, such as, by securement straps, snaps, or magnetic coupling, or other suitable securing mechanisms.

In an open position, the first and second walls 852, 854 are oriented at an angle of 180° relative to one another. The first and second walls 852, 854 and the respective portions 858 and apertures 860a, 860b are substantially symmetrical about the hinge 856 (axis C′). As such, when the walls 852, 854 are adhered, the apertures 860a, 860b align and create a handle for transporting the blood bag 10. The blood bag is therefore transferable without direct handling, thereby preventing unnecessary heat exchange and increasing viable usage time of the blood bag 10. While in the open position, the blood bag 10 is placed against one of the first or second walls 852, 854. The other of the first or second wall 852, 854 is rotated about the axis C′ to cover the blood bag 10 such that the adhesive strip bonds the first and second walls 852, 854 together and therefore, securing the blood bag 10 therebetween. When the blood bag 10 is installed, the through-hole 30 of the blood bag is exposed and accessible at a first end 868 of the device 850 while the ports 26 and tubes 28 of the blood bag are exposed and accessible at a second end 870 of the device 850.

In the embodiment illustrated in FIG. 49, the first and second walls 852, 854 are constructed from insulative plastic 50 having substantially square pockets 56 at the first end 868 and substantially rectangular pockets 56 at the second end 870. Additionally, elongate air pockets 56 extend between the first and second ends 868, 870 of the device 850 on opposite sides of the window 862 on each of the first and second walls 852, 854. The device 850 is configured to have a pocket thickness in the range of about 8 mm-10 mm such that walls 852, 854 when secured relative to one another may accommodate bags having small volumes (e.g., 100 ml) and large volumes (e.g., 350 ml). The pocket thickness allows the device 850 to be horizontally flexible (i.e., in a direction perpendicular to the axis C′). In further embodiments, the insulation device 850 may be constructed from insulative plastic 50 having any suitable density, size, shape and orientation of the pockets. Additionally, the window 862, which may be a thin layer of insulative plastic or an air pocket having any suitable thickness, may be included on either or both of the walls 852, 854. The pocket thickness of the window 862 and the air pockets 56 may have any suitable dimensions in the range of about 0.5 mm-3.0 cm. Additionally, the pocket thickness may be uniform or variable for each of the first or second walls 852, 854. Further, while the embodiment illustrated in FIG. 49 is constructed from insulative plastic, other embodiments may include any combination of insulative materials discussed herein. Moreover, while the pockets in the illustrated embodiment are oriented vertically, it is contemplated that they may be oriented horizontally or in another direction.

Each of the above-described embodiments uses at least insulative plastic or insulative foam to insulate blood bags. The embodiments are not limited to the dimensions, shapes or configurations that are indicated in the corresponding figures. Rather, the figures merely serve as examples of the various constructions that a blood bag insulation device may take in order to provide insulation, reduce handling, and prolong the viable time of each blood bag. Any of these embodiments may also include a temperature indicator, i.e., a thermometer or temperature sensor, to help the clinicians monitor changes in temperature over the use of a blood bag. Additionally, notification sensors that emit visual and/or audible cues may be coupled to the temperature indicators that are equipped to alert the clinician if and when the blood bag reaches a temperature that is still within the desired range and/or a temperature that is outside the desired range. The insulation devices, temperature indicators, and sensor/alarm systems may be reusable or disposable, as well, depending on the embodiment.

Thus, embodiments of the invention provide, among other things insulation devices for blood bags that reduce heat transfer to the blood bag and prolong the time period for which a blood bag is viable outside of refrigerated storage.

What is claimed is:

1. An insulation device for insulating a blood bag, the blood bag including a cavity defined by a first side, a second side, a top, and a bottom, the bottom of the bag including at least one port and the top of the bag including a through-hole, the bag including a label, the insulation device comprising:
a body including a first end and a second end, and at least partially constructed from an insulative material;
wherein the body is configured to at least partially surround the blood bag such that the at least one port and the through-hole are accessible.

2. The insulation device of claim 1, wherein the label is visible when the blood bag is at least partially surrounded by the body.

3. The insulation device of claim 1, wherein the insulative material is at least partially constructed from one of poly-vinyl chloride, low-density polyethylene, polyurethane foam, and neoprene foam.

4. The insulation device of claim 1, wherein the insulative material includes a plurality of pockets.

5. The insulation device of claim 1, wherein the body includes at least one opening such that when the bag is surrounded by the body, the at least one port of the bag extends through the opening.

6. An insulation device for insulating a blood bag, the blood bag including a cavity defined by a first side, a second side, a top, and a bottom, the bottom of the bag including at least one port and the top of the bag including a through-hole, the bag including a label, the insulation device comprising:
a body including a first end and a second end;
a first wall and a second wall defining a cavity extending between the first end and the second end;
wherein the body of the device is at least partially constructed from an insulative material;
wherein the body of the device at least partially surrounds the blood bag such that the cavity of the blood bag is at least partially positioned between the first wall and the second wall;
wherein when the blood bag is surrounded by the body of the device, the at least one port and the through-hole are accessible.

7. The insulation device of claim 6, wherein the label is visible when the blood bag is surrounded by the body of the device.

8. The insulation device of claim 6, wherein the insulative material is at least partially constructed from one of poly-vinyl chloride, low-density polyethylene, polyurethane foam, or neoprene foam.

9. The insulation device of claim 6, wherein the insulative material includes a plurality of pockets.

10. The insulation device of claim 6 further comprising a handle.

11. The insulation device of claim 6 wherein the body of the device includes at least one opening such that when the blood bag is at least partially surrounded by the body of the device, the at least one port of the bag extends through the opening.

12. The insulation device of claim 6 wherein at least one of the first wall and the second wall includes a through-hole such that when the blood bag is surrounded by the body of the device, the through-hole of the bag is aligned with the at least one through-hole of the device.

13. The insulation device of claim 6 further comprising at least one closure member extending between the first wall and the second wall.

14. The insulation device of claim 6 wherein the first wall is hingedly coupled to the second wall.

15. The insulation device of claim 6 wherein the insulative material has a thickness that is configured to accommodate the blood bag when substantially full and substantially empty.

16. An insulation device for insulating a blood bag, the blood bag including a cavity defined by a first side, a second side, a top, and a bottom, the bottom of the bag including at least one port and the top of the bag including a through-hole, the bag including a label, the insulation device comprising:
a body including a first end and a second end, the body at least partially constructed from an insulative material and configured to at least partially surround the cavity of the blood bag;
a window in the body, the label visible through the window when the blood bag is at least partially surrounded by the body of the device; and
a closure member coupled to the body for restricting movement of the blood bag relative to the body of the device;
wherein when the blood bag is at least partially surrounded by the body of the device, the at least one port and the through-hole are accessible.

17. The insulation device of claim 16, wherein the insulative material is at least partially constructed from one of poly-vinyl chloride, low-density polyethylene, polyurethane foam, or neoprene foam.

18. The insulation device of claim 16, wherein the insulative material includes a plurality of pockets.

19. The insulation device of claim 16 wherein the insulative material has a thickness that is configured to accommodate the blood bag when substantially full and substantially empty.

20. The insulation device of claim 16 wherein the body of the device includes at least one opening such that when the blood bag is surrounded by the body of the device, the at least one port of the blood bag extends through the opening.
